(19) United States
(12) Patent Application Publication
(10) Pub. No.: US 2026/0254089 A1
(43) Pub. Date: Aug. 27, 2026

(54) WAVEGUIDE DEVICE

(71) Applicant: TAIYO YUDEN CO., LTD., Tokyo (JP)

(72) Inventors: Hitoshi TANAKA, Tokyo (JP); Yutaka AOKI, Tokyo (JP); Hiroyuki KAMO, Tokyo (JP)

(73) Assignee: TAIYO YUDEN CO., LTD., Tokyo (JP)

(21) Appl. No.: 19/648,436

(22) Filed: Apr. 15, 2026

Related U.S. Application Data
(63) Continuation of application No. PCT/JP2024/030745, filed on Aug. 28, 2024.

(30) Foreign Application Priority Data
Oct. 18, 2023 (JP) 2023-179754

(51) Int. Cl. H01P 3/123

(52) U.S. Cl. CPC H01P 3/123

(57) ABSTRACT

A waveguide device includes a first member having an upper surface with conductivity, a second member having a lower surface with conductivity, the lower surface facing the upper surface of the first member, a ridge disposed on the upper surface of the first member between the upper surface of the first member and the lower surface of the second member, a characteristic adjustment body disposed on the upper surface of the first member, the characteristic adjustment body having one end connected to a side of the ridge and another end being an open end, and a plurality of rods provided at least around the ridge and the characteristic adjustment body, each of rods being in contact with one of the upper surface of the first member and the lower surface of the second member and forming a third gap between the rods and another thereof.

### CROSS-REFERENCE TO RELATED APPLICATION

This application is a continuation application of International Application PCT/JP2024/030745 filed on August 28, 2024 and designated the U.S., which claims the benefits of priorities of Japanese Patent Application No. 2023-179754 filed on October 18, 2023, the entire contents of which are incorporated herein by reference.

### FIELD

A certain aspect of the present disclosure relates to a waveguide device.

### BACKGROUND

In recent years, research and development on sensing and communication using millimeter waves have been expanded, and an antenna having a high gain, low-loss, a wide bandwidth, and multiple channels has been required. In response to this, development of WRG (Waffle iron Ridge waveGuide) technology useful as a next-generation antenna and a waveguide has progressed (for example, Patent Document 1: International Publication Pamphlet No. WO 03/065497, and Patent Document 2: Japanese National Publication of International Patent Application No. 2011-527171). FIG. 3 of Patent Document 1 discloses a basic structure of the WRG. As a subordinate supplementary structure thereof, Patent Document 2 discloses a structure in which two conductive members constituting a basic structure are fixed outside a waveguide region as one of structures of the WRG in a high frequency band such as a millimeter wave. One of the features of the WRG technology is that separation walls are formed to prevent mutual coupling between adjacent waveguides in a plurality of waveguides in an antenna disposed from a millimeter wave IC (MMIC: Monolithic Microwave Integrated Circuit) to an antenna radiation aperture for transmitting and receiving a millimeter wave electromagnetic wave. This prevents leakage of the propagating electromagnetic wave, thereby keeping the transmission loss at the same level as that of the metal waveguide, and minimizing interference with the electromagnetic wave transmitted through another adjacent waveguide. In the microstrip waveguides and microstrip antennas used hitherto, such separation walls do not exist.

A main application field of the millimeter wave antenna is an application of imaging radar sensing having a plurality of transmission/reception channels. When a microstrip antenna is used for this antenna application, a loss in a waveguide is large, and interference due to mutual coupling between waveguides and antenna radiation elements adjacent to each other in the antenna occurs, which may cause a problem in detection accuracy of an object or the like. On the other hand, when the WRG technology is used for such a multi-channel antenna, in addition to keeping the loss in the waveguide extremely low, the mutual coupling between the waveguides adjacent to each other in the antenna is greatly suppressed. In addition, the mutual coupling can be further suppressed by using the antenna radiation aperture suitable for WRG such as a mini-horn antenna or a slot antenna. This enables correct signal transmission/reception between the antenna transmission/reception aperture and the MMIC terminal that performs signal transmission and reception. As a result, for example, in millimeter wave radar sensing, it is possible to correctly detect a signal of the object included in a received electromagnetic wave from the object and accurately detect the object.

In the WRG technology, the separation walls are realized by magnetic walls provided on both sides of the ridge waveguide, and are realized by a structure having periodicity such as a rod array. When the magnetic wall is realized by a single rod array, a separation effect of about 30 dB can be expected. In order to further enhance the separation effect, when two rod rows are provided between two ridge waveguides, the separation effect is expected to be about 40dB, and high separation performance suitable for an array antenna can be realized. Such a magnetic wall has a confinement function of stopping propagation of an electromagnetic wave in a corresponding frequency band. The structure constituting this is called an artificial magnetic conductor (AMC), and can be realized by a structure other than the rod array (for example, Patent Document 2: Japanese National Publication of International Patent Application No. 2011-527171). For example, the description in the middle of paragraph of Patent Document 2 is instructive, which states: “the texture or structure is often periodic or quasi-periodic and is made to interact with waves to macroscopically operate as an artificial magnetic conductor (AMC), an electromagnetic band gap (EBG) surface, or a soft surface”.

In recent years, development using the WRG technology for radar and communication applications has been advanced. For example, a technique has been proposed in which the phase of a propagating electromagnetic wave is controlled by providing irregularities on the upper surface of a ridge waveguide (for example, Patent Document 3: Japanese National Publication of International Patent Application No. 2018-511187). In addition, a technique has been proposed in which the reflection of electromagnetic waves is adjusted and matched by providing irregularities on the upper surface of a bent portion of the ridge waveguide or the like (for example, Patent Document 4: Japanese Patent Application Publication No. 2017-130924).

### SUMMARY OF THE INVENTION

According to a first aspect of the present disclosure, there is provided a waveguide device including: a first member having an upper surface with conductivity; a second member having a lower surface with conductivity, the lower surface facing the upper surface of the first member; a ridge disposed on the upper surface of the first member between the upper surface of the first member and the lower surface of the second member, the ridge forming a first air gap between the ridge and the lower surface of the second member, the ridge having a first waveguide surface with conductivity facing the lower surface of the second member; a characteristic adjustment body disposed on the upper surface of the first member between the upper surface of the first member and the lower surface of the second member, the characteristic adjustment body having a second waveguide surface with conductivity facing the lower surface of the second member with a second air gap interposed therebetween, the characteristic adjustment body having one end connected to a side of the ridge and another end being an open end; and a plurality of rods provided at least around the ridge and the characteristic adjustment body between the upper surface of the first member and the lower surface of the second member, each of the plurality of rods being in contact with one of the upper surface of the first member and the lower surface of the second member and forming a third gap between the rods and another of the upper surface and the lower surface, each of the plurality of rods having at least an upper surface with conductivity and a side surface with conductivity.

According to a second aspect of the present disclosure, there is provided a waveguide device including: a first member having an upper surface with conductivity; a second member having a lower surface with conductivity, the lower surface facing the upper surface of the first member; a ridge disposed on the upper surface of the first member between the upper surface of the first member and the lower surface of the second member, the ridge forming a first air gap between the ridge and the lower surface of the second member, the ridge having a first waveguide surface with conductivity facing the lower surface of the second member; a characteristic adjustment body disposed on the upper surface of the first member between the upper surface of the first member and the lower surface of the second member, the characteristic adjustment body having a second waveguide surface with conductivity facing the lower surface of the second member with a second air gap interposed therebetween, the characteristic adjustment body having one end connected to a side of the ridge, at least a portion of the second waveguide surface being in contact with or high-frequency coupled to the lower surface of the second member by a conductor; and a plurality of rods provided at least around the ridge and the characteristic adjustment body between the upper surface of the first member and the lower surface of the second member, each of the plurality of rods being in contact with one of the upper surface of the first member and the lower surface of the second member and forming a third gap between the rods and another of the upper surface and the lower surface, each of the plurality of rods having at least an upper surface with conductivity and a side surface with conductivity.

According to a third aspect of the present disclosure, there is provided a waveguide device including: a first member having an upper surface with conductivity and a through hole having a waveguide function; a second member having a lower surface with conductivity, the lower surface facing the upper surface of the first member; a ridge disposed on the upper surface of the first member between the upper surface of the first member and the lower surface of the second member, the ridge forming a first air gap between the ridge and the lower surface of the second member, the ridge having a first waveguide surface with conductivity facing the lower surface of the second member, the ridge having one end connected to the through hole; a characteristic adjustment body disposed on the upper surface of the first member between the upper surface of the first member and the lower surface of the second member, the characteristic adjustment body having a second waveguide surface with conductivity facing the lower surface of the second member with a second air gap interposed therebetween, (i) the characteristic adjustment body having one end connected to the through hole and another end being an open end or (ii) the characteristic adjustment body having one end connected to the through hole, at least a portion of the second waveguide surface being in contact with or high-frequency coupled to the lower surface of the second member by a conductor; and a plurality of rods provided at least around the ridge and the characteristic adjustment body between the upper surface of the first member and the lower surface of the second member, each of the plurality of rods being in contact with one of the upper surface of the first member and the lower surface of the second member and forming a third gap between the rods and another of the upper surface and the lower surface, each of the plurality of rods having at least an upper surface with conductivity and a side surface with conductivity.

### BRIEF DESCRIPTION OF THE DRAWINGS

FIG. 1A is a plan view of a waveguide device according to a first embodiment.

FIGS. 1B and 1C are cross-sectional views taken along lines A-A and B-B in FIG. 1A, respectively.

FIG. 2A is a perspective view of a waveguide device according to a second embodiment.

FIG. 2B is a plan view of the waveguide device.

FIG. 2C is a cross-sectional view taken along a line A-A in FIG. 2B.

FIGS. 3A to 3D illustrate simulation results of the waveguide device according to the second embodiment.

FIGS. 4A to 4D illustrate simulation results when the height of the characteristic adjustment body is changed in the waveguide device according to the second embodiment.

FIGS. 5A and 5B illustrate simulation results of frequency characteristics when the height of the characteristic adjustment body is changed in the waveguide device according to the second embodiment.

FIGS. 6A and 6B are cross-sectional views of the waveguide device when the height of the characteristic adjustment body is changed in the waveguide device according to the second embodiment.

FIGS. 7A and 7B are perspective views of a waveguide device according to a first modification of the second embodiment.

FIGS. 8A to 8D illustrate simulation results when the height of the characteristic adjustment body and the height of a ridge in a recess or a protrusion are changed together in the waveguide device according to the first modification of the second embodiment.

FIGS. 9A and 9B are cross-sectional views of a waveguide device according to a second modification of the second embodiment.

FIGS. 10A to 10D illustrate simulation results when the height of the characteristic adjustment body is changed by various inclination angles in the waveguide device according to the second modification of the second embodiment.

FIGS. 11A and 11B are cross-sectional views of a waveguide device according to a third modification of the second embodiment.

FIGS. 12A to 12C are cross-sectional views of a waveguide device according to a fourth modification of the second embodiment.

FIG. 13 is a plan view of a waveguide device according to a fifth modification of the second embodiment.

FIGS. 14A to 14C are perspective views of a waveguide device according to a sixth modification of the second embodiment.

FIG. 15A illustrates a simulation result when the central angle of the characteristic adjustment body is changed in the waveguide device according to the sixth modification of the second embodiment.

FIG. 15B illustrates a simulation result when the height of the characteristic adjustment body is changed.

FIG. 16A is a perspective view of a waveguide device according to a seventh modification of the second embodiment.

FIGS. 16B and 16C are cross-sectional views taken along lines A-A and B-B in FIG. 16A, respectively.

FIGS. 17A and 17B are cross-sectional views of a waveguide device according to an eighth modification of the second embodiment.

FIGS. 18A to 18C illustrate simulation results of models A, B, and C.

FIG. 19A is a plan view of a waveguide device in accordance with a ninth modification of the second embodiment.

FIG. 19B is a plan view of a waveguide device according to a tenth modification of the second embodiment.

FIG. 20A is a perspective view of a waveguide device according to an eleventh modification of the second embodiment.

FIG. 20B is a cross-sectional view taken along a line A-A in FIG. 20A.

FIG. 21 illustrates simulation results of insertion loss of the waveguide devices according to the second embodiment and the ninth to eleventh modifications of the second embodiment.

FIG. 22A is a plan view of a waveguide device according to twelfth to fourteenth modifications of the second embodiment.

FIGS. 22B to 22D are cross-sectional views of the waveguide device according to the twelfth to fourteenth modifications of the second embodiment.

FIGS. 23A to 23C are plan views of waveguide devices according to fifteenth to seventeenth modifications of the second embodiment.

FIG. 24A is a plan view of a waveguide device according to a third embodiment.

FIGS. 24B and 24C are cross-sectional views taken along lines A-A and B-B in FIG. 24A, respectively.

FIG. 25A is a perspective view of a waveguide device according to a fourth embodiment.

FIG. 25B is a plan view of the waveguide device according to the fourth embodiment.

FIG. 25C is a cross-sectional view taken along a line A-A in FIG. 25B.

FIGS. 26A and 26B illustrate simulation results when the height of the characteristic adjustment body is changed in the waveguide device according to the fourth embodiment.

FIGS. 27A and 27B are cross-sectional views of a waveguide device according to a fourth embodiment when the height of the characteristic adjustment body is changed.

FIGS. 27C and 27D are cross-sectional views of the waveguide device according to the fourth embodiment when the characteristic adjustment body is high-frequency coupled to a second member.

FIGS. 28A and 28B are perspective views of a waveguide device according to a first modification of the fourth embodiment.

FIGS. 29A and 29B are cross-sectional views of a waveguide device according to a second modification of the fourth embodiment.

FIGS. 29C and 29D are cross-sectional views of a waveguide device according to a third modification of the fourth embodiment.

FIGS. 30A to 30C are cross-sectional views of a waveguide device according to a fourth modification of the fourth embodiment.

FIG. 31A is a plan view of a waveguide device according to a fifth modification of the fourth embodiment.

FIG. 31B is a plan view of a waveguide device according to a sixth modification of the fourth embodiment.

FIG. 32A is a cross-sectional view of a waveguide device according to a seventh modification of the fourth embodiment.

FIGS. 32B and 32C are cross-sectional views of waveguide devices according to an eighth modification of the fourth embodiment.

FIG. 33A is a plan view of a waveguide device according to a fifth embodiment.

FIGS. 33B and 33C are cross-sectional views taken along lines A-A and B-B in FIG. 33A, respectively.

FIG. 34A is a plan view of a waveguide device according to a sixth embodiment.

FIGS. 34B to 34D are cross-sectional views of the waveguide device according to the sixth embodiment.

FIG. 35 illustrates simulation results when the height of an air gap is changed in the waveguide device according to a thirteenth modification of the second embodiment;

FIG. 36A is a plan view of a waveguide device according to a seventh embodiment.

FIGS. 36B and 36C are cross-sectional views taken along lines A-A and B-B in FIG. 36A, respectively.

FIG. 37A is a plan view of a waveguide device according to an eighth embodiment.

FIGS. 37B to 37D are cross-sectional views of the waveguide device according to the eighth embodiment.

FIGS. 38A to 38D are plan views illustrating other examples of a through hole.

FIG. 39 is a cross-sectional view illustrating another example of the rod.

### DESCRIPTION OF EMBODIMENTS

Patent Document 3 (Japanese National Publication of International Patent Application No. 2018-511187) and Patent Document 4 (Japanese Patent Application Publication No. 2017-130924) disclose means for adjusting the characteristics of the ridge waveguide, which is a main waveguide of the WRG technology. In recent years, in response to the expansion of the applications of the WRG technology, there are cases where only the adjustment of characteristics in the ridge waveguide, which is the main waveguide, is insufficient. Therefore, it is required to obtain desired characteristics by indirectly adjusting the characteristics in a peripheral portion other than the main waveguide of the WRG technology.

The present disclosure has been made in view of the above problems, and an object of the present disclosure is to provide a waveguide device capable of adjusting to desired characteristics.

### DETAILED DESCRIPTION OF THE INVENTION

Hereinafter, embodiments of the present disclosure will be described with reference to the drawings.

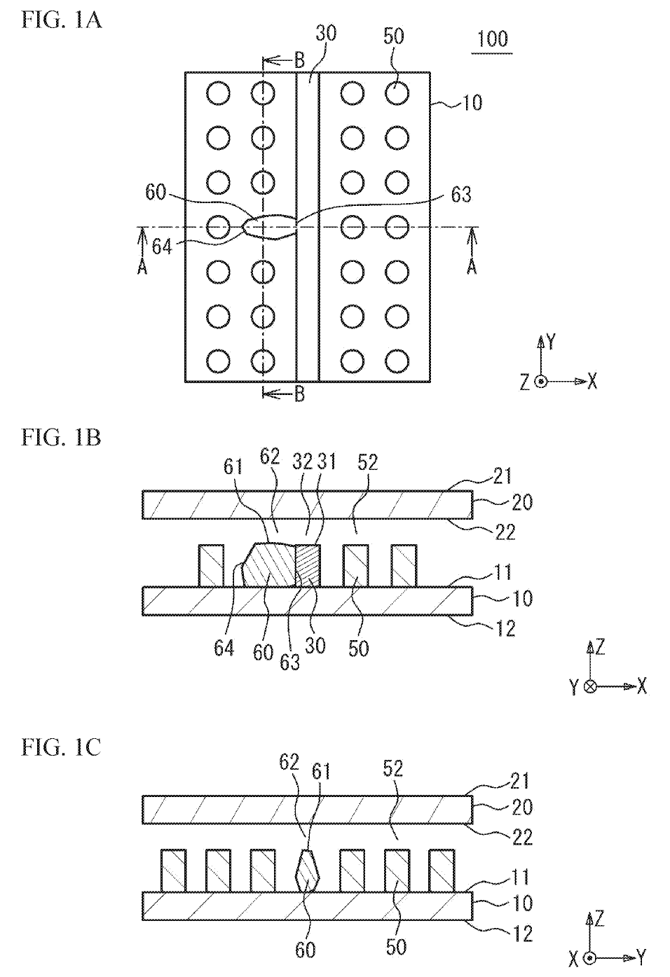

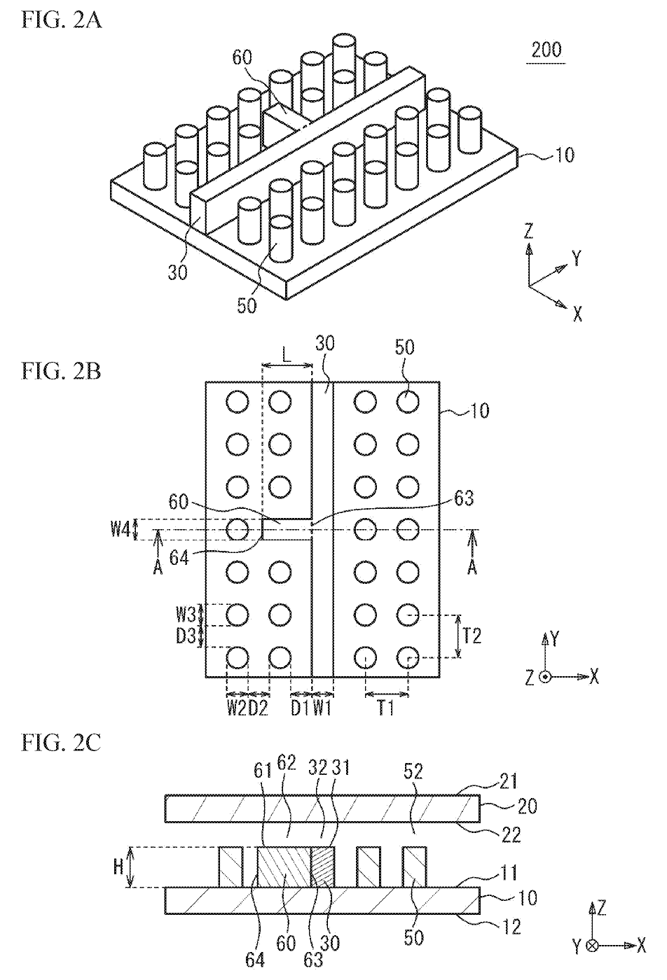

In the first embodiment (FIGS. 1A to 1C) and the second embodiment (FIGS. 2A to 23C and 35), a case where a characteristic adjustment body having one end connected to a side of a ridge and the other end being an open end is provided on an upper surface of a first member will be described.

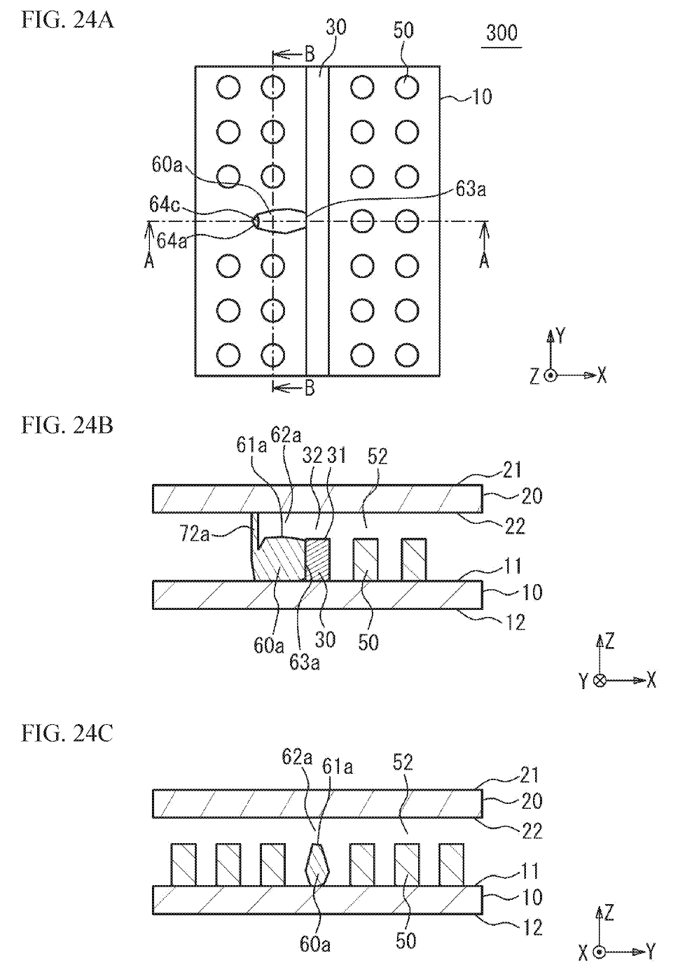

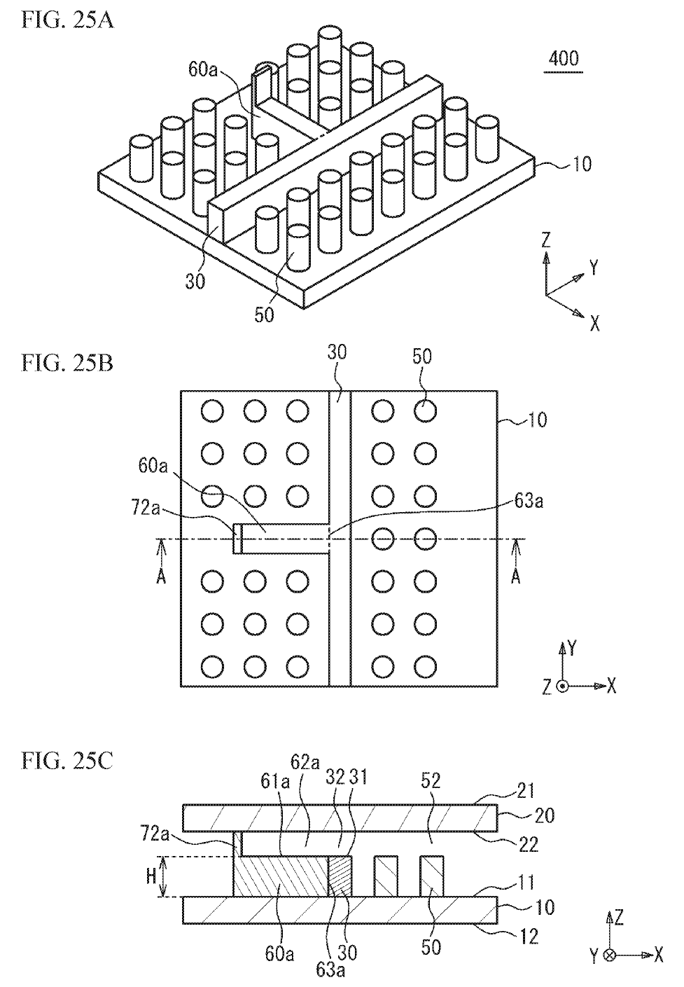

In the third embodiment (FIGS. 24A to 24C) and the fourth embodiment (FIGS. 25A to 32C), a case where a characteristic adjustment body having one end connected to the side of the ridge and being in contact with or high-frequency coupled to a lower surface of a second member by a conductor is provided on the upper surface of the first member will be described.

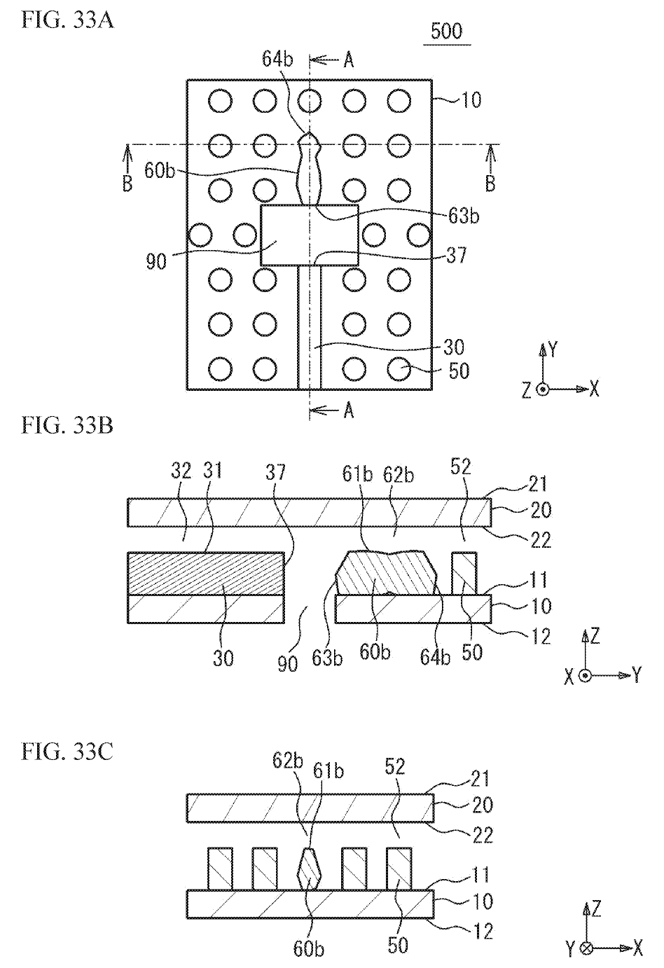

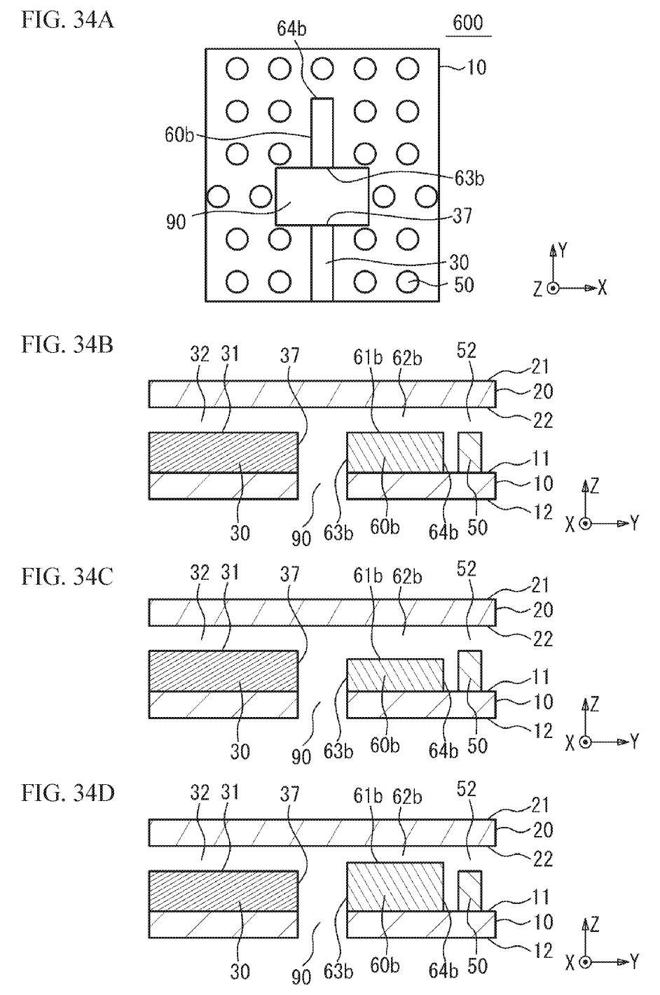

In the fifth embodiment (FIGS. 33A to 33C) and the sixth embodiment (FIGS. 34A to 34D), a case where a characteristic adjustment body having one end connected to a through hole and the other end being an open end is provided on the upper surface of the first member will be described.

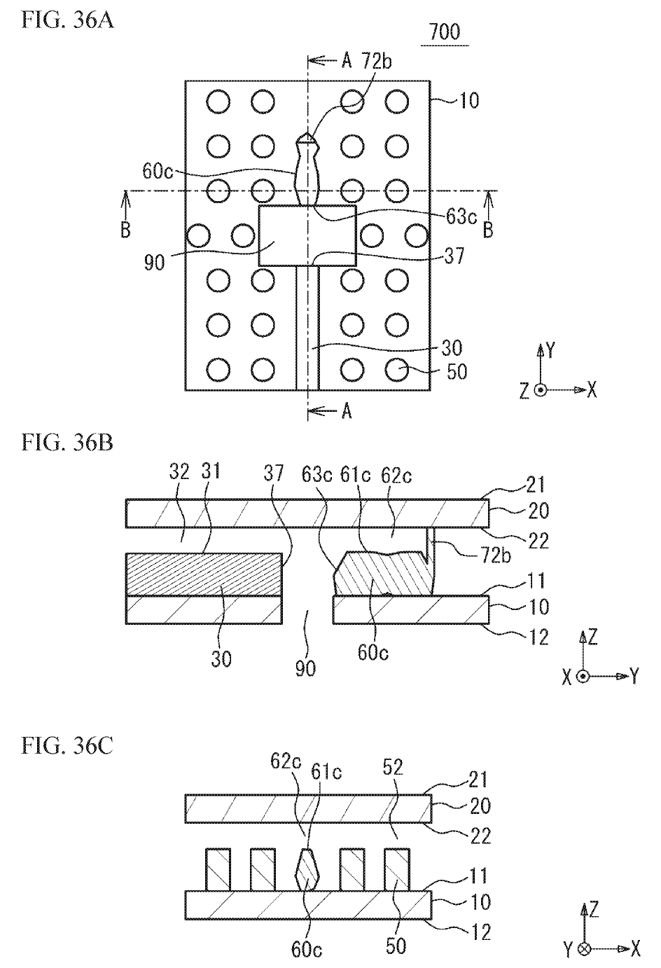

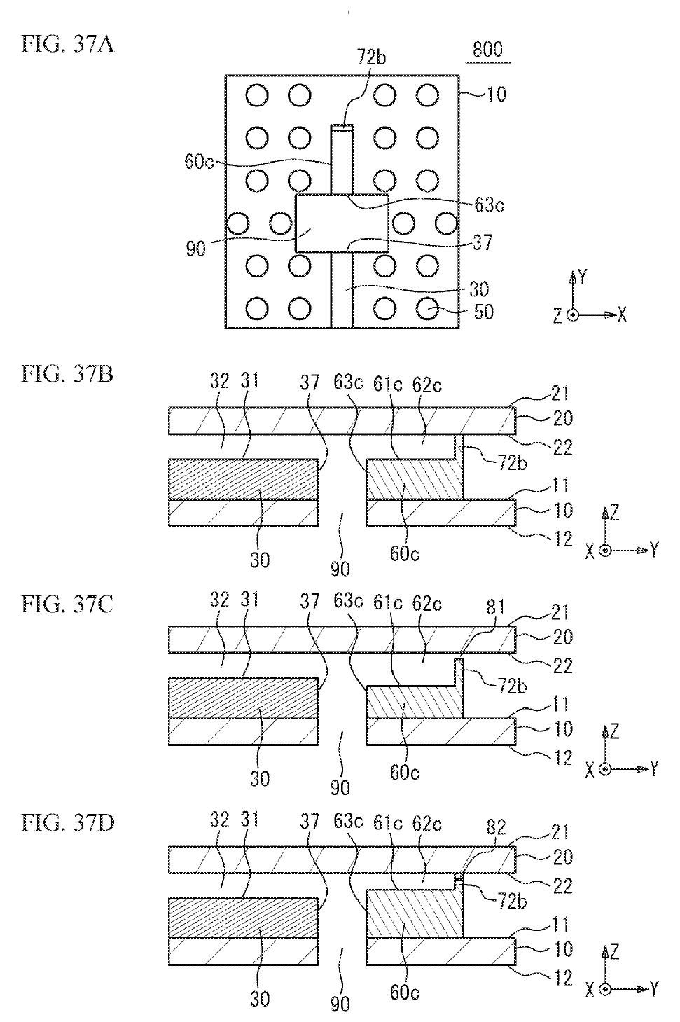

In the seventh embodiment (FIGS. 36A to 36C) and the eighth embodiment (FIGS. 37A to 37D), a case where a characteristic adjustment body having one end connected to a through hole and being in contact with or high-frequency coupled to the lower surface of the second member by the conductor is provided on the upper surface of the first member will be described.

### First Embodiment

The first embodiment is an example of a case where a characteristic adjustment body 60 having one end 63 connected to a side of a ridge 30 and the other end 64 being an open end is provided on an upper surface 11 of a first member 10. FIG. 1A is a plan view of a waveguide device 100 according to the first embodiment, and FIGS. 1B and 1C are cross-sectional views taken along lines A-A and B-B in FIG. 1A, respectively. In FIG. 1A, a second member 20 is illustrated transparently (the same applies to similar drawings below). Directions orthogonal to each other on the upper surface 11 of the first member 10 are defined as an X-axis direction and a Y-axis direction, and a direction perpendicular to the upper surface 11 is defined as a Z-axis direction. In addition, the "upper surface" of the first member 10 in this specification refers to an aggregate of surfaces that can be recognized on the surface of the first member 10 when the first member 10 disposed along an XY plane is viewed from a +Z-axis direction. For example, in the case where the surface of the first member 10 has irregularities, the "upper surface" includes all the irregular surfaces seen from the Z-axis direction. In addition, even if there are step surfaces or staircase surfaces, these are also included in the "upper surface". The term "lower surface" is used in the same meaning. The term "upper surface side" is used to mean "above including the upper surface". The same applies to the "lower surface side". The same applies to the second member 20. Furthermore, the expressions "upper" and "lower" used in the present specification and the claims are used for convenience in order to make the description of the relative positions of objects easier to understand, and do not limit the scope of the claimed invention.

As illustrated in FIGS. 1A to 1C, the waveguide device 100 according to the first embodiment includes the first member 10, the second member 20, the ridge 30, a plurality of rods 50, and the characteristic adjustment body 60. The first member 10 has the upper surface 11 with conductivity and a lower surface 12 corresponding to the back side of the upper surface 11. The second member 20 is located on the upper surface 11 side of the first member 10, overlaps the first member 10 in planar view in the Z-axis direction, and has a lower surface 22 with conductivity facing the upper surface 11 and an upper surface 21 corresponding to the back side of the lower surface 22. The first member 10 and the second member 20 are, for example, plate-shaped members. Alternatively, a member obtained by forming a conductive film on the surface of a member molded from a resin may be used. The first member 10 and the second member 20 both extend substantially along the XY plane and are disposed substantially parallel to each other. Here, the "facing surface" refer to a surface that falls in the field of view when viewed from an observation point on one surface toward the other surface in the Z-axis direction. Therefore, a back face located in an L-shaped recess that falls outside the field of view is not defined as a facing surface.

The ridge 30 has conductivity at least on its upper surface, and is provided to extend in the Y direction between the upper surface 11 of the first member 10 and the lower surface 22 of the second member 20. The side surface of the ridge 30 preferably has conductivity, but the present disclosure functions even if the side surface does not have conductivity. In the case where the side surface of the ridge 30 has conductivity, an end of the ridge 30 in the -Z direction may contact the upper surface 11 of the first member 10. An end of the ridge 30 in the +Z direction is not in contact with the second member 20 and is separated from the lower surface 22 of the second member 20. The upper surface (an end surface on the +Z direction side) of the ridge 30 facing the lower surface 22 of the second member 20 is a first waveguide surface 31 with conductivity. The first waveguide surface 31 extends along the ridge 30. A first air gap 32 is formed between the lower surface 22 of the second member 20 and the first waveguide surface 31 of the ridge 30. In the first air gap 32, a ridge waveGuide (WRG: Waffle-iron Ridge waveGuide), which is a main waveGuide through which an electromagnetic wave is transmitted, is formed.

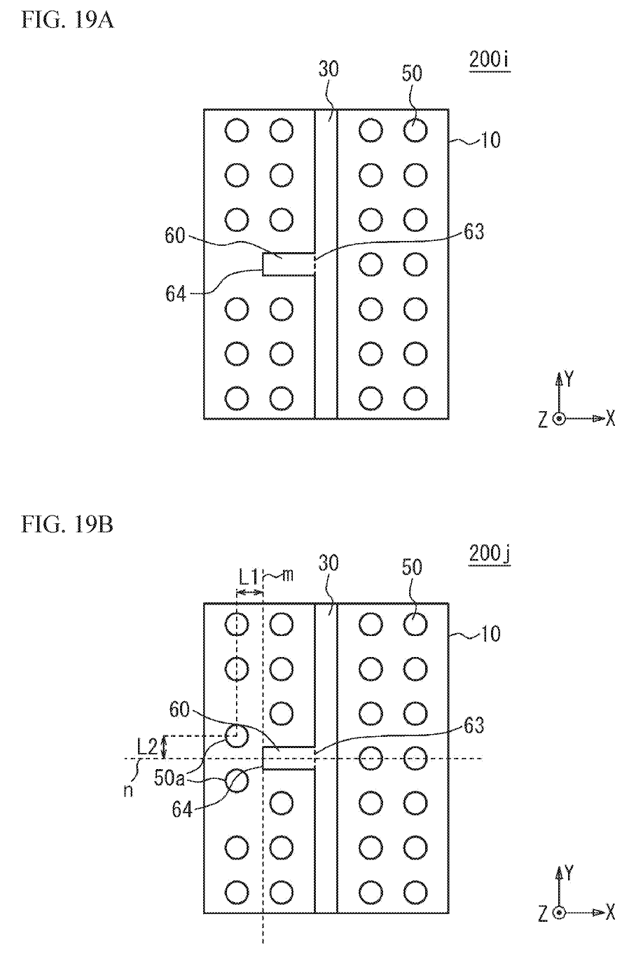

The characteristic adjustment body 60 has conductivity at least on its upper surface, and is provided between the upper surface 11 of the first member 10 and the lower surface 22 of the second member 20. The characteristic adjustment body 60 has an end 63 in the +X direction connected to a side of the ridge 30, and the end 64 in the -X direction as an open end. In the present embodiment, the side surface of the characteristic adjustment body 60 also has conductivity, and the end of the side surface of the characteristic adjustment body 60 in the -Z direction is in contact with the upper surface 11 of the first member 10. The end of the characteristic adjustment body 60 in the +Z direction is not in contact with the lower surface 22 of the second member 20, and is separated from the lower surface 22 of the second member 20. The characteristic adjustment body 60 may have any shape. The upper surface (the end surface on the +Z direction side) of the characteristic adjustment body 60 that faces the lower surface 22 of the second member 20 constitutes a second waveguide surface 61 with conductivity. A second air gap 62 is formed between the lower surface 22 of the second member 20 and the second waveguide surface 61 of the characteristic adjustment body 60. A waveguide for transmitting the electromagnetic wave is formed in the second air gap 62. A waveguide formed by the first waveguide surface 31 and the lower surface 22 of the second member 20 and a waveguide formed by the second waveguide surface 61 and the lower surface 22 of the second member 20 are connected to each other at the end 63 of the characteristic adjustment body 60 in the + X direction and on the side of the ridge 30. Here, the characteristic adjustment body 60 being "connected" to the side of the ridge 30 means a state in which a ridge waveguide on the ridge 30 and the waveguide on the characteristic adjustment body 60 are connected to each other as a waveguide. The "open end" refers to a state in which the end 64 of the characteristic adjustment body 60 is not adjacent to another waveguide but is adjacent to a portion blocked as a waveguide such as the rod 50 or an electric wall. In addition, the state illustrated in FIG. 19A in which the rod 50 is not provided is also included.

The plurality of rods 50 have conductivity on the upper surface and the side surface thereof, and are provided at least around the ridge 30 and the characteristic adjustment body 60 between the upper surface 11 of the first member 10 and the lower surface 22 of the second member 20. Here, "adjacent" means a state in which the rods 50 are arranged in proximity to each other via a space or a dielectric without interposing another conductive object at a position where a required function, that is, a function of realizing an electromagnetic wave blocking function for the ridge 30 and the characteristic adjustment body 60 in a case where the rods are used, is realized. In such a case, a distance between two adjacent members having conductive surfaces is, for example, about λ₀/4. Note that a case where a required function can be realized even at a distance longer than this is included in "adjacent". The end of the side surface of the rod 50 in the -Z direction is in contact with the upper surface 11 of the first member 10. The end of the side surface of the rod 50 in the +Z direction is not in contact with the lower surface 22 of the second member 20, and a third air gap 52 is formed between the end and the second member 20. The rod 50 has, for example, a cylindrical shape, but may have a shape other than the cylindrical shape, such as a rectangular parallelepiped shape or an elliptical columnar shape. At least a part of the side surface of the rod 50 may be tapered, or the corner of the tip surface of the rod 50 may be chamfered.

The plurality of rods 50 arranged around the ridge 30 and the characteristic adjustment body 60 form an artificial magnetic conductor which is a structure that artificially realizes the properties of a complete magnetic conductor. An artificial magnetic conductor is a structure that artificially realizes the properties of a perfect magnetic conductor (PMC) that does not exist in nature. The plurality of rods 50 are arranged around the ridge 30 and the characteristic adjustment body 60, and thus the plurality of rods 50 function as magnetic walls. As a result, the electromagnetic wave transmitted through the ridge waveguide on the ridge 30 and the electromagnetic wave transmitted through the waveguide on the characteristic adjustment body 60 are suppressed from leaking laterally. The ridge waveguide provided between the plurality of rods 50 functioning as artificial magnetic conductors transmits the electromagnetic wave in the microwave or millimeter wave band with low loss.

According to the first embodiment, the characteristic adjustment body 60 is provided that has the second waveguide surface 61 disposed on the upper surface 11 of the first member 10 and facing the lower surface 22 of the second member 20 with the second air gap 62 interposed therebetween, and that has the one end 63 connected to the side of the ridge 30 and the other end 64 that is an open end. By providing the characteristic adjustment body 60, the waveguide device can be adjusted to have desired characteristics. Since the characteristics of the waveguide device having the characteristic adjustment body 60 can be obtained by simulation, the waveguide device can be adjusted to desired characteristics by adjusting the shape of the characteristic adjustment body 60 using simulation. The characteristic adjustment body 60 can be manufactured to have a desired shape by molding or the like.

### Second Embodiment

The second embodiment and its modifications indicate that the characteristics of the ridge waveguide connected to the characteristic adjustment body 60 are changed by changing the shape of the characteristic adjustment body 60 described in the first embodiment. Therefore, a characteristic adjustment body having a simple shape is illustrated, and the simulation result is illustrated, thereby specifically describing the present disclosure. First, in a second embodiment, an example of a waveguide device including a rectangular parallelepiped characteristic adjustment body will be described. In the following description including the present embodiment, the side surface of the characteristic adjustment body is assumed to have conductivity. However, the present disclosure functions even when the side surface has no conductivity and only the upper surface has conductivity. FIG. 2A is a perspective view of a waveguide device 200 according to a second embodiment, FIG. 2B is a plan view of the waveguide device 200 according to the second embodiment, and FIG. 2C is a cross-sectional view taken along a line A-A in FIG. 2B. As illustrated in FIGS. 2A to 2C, the waveguide device 200 according to the second embodiment includes the first member 10, the second member 20, the ridge 30, the plurality of rods 50, and the characteristic adjustment body 60, similarly to the waveguide device 100 according to the first embodiment. In the second embodiment, the characteristic adjustment body 60 has a rectangular parallelepiped shape.

As in the first embodiment, the ridge 30, the rod 50, and the characteristic adjustment body 60 are in contact with the upper surface 11 of the first member 10, and are not in contact with the second member 20, but are separated from the lower surface 22 of the second member 20. Here, "contact" refers to a state in which two members having a conductive surface are electrically connected to each other, such as a case where the two members are physically in contact with each other and fixed with a screw or the like, a case where the two members having a conductive surface are integrally formed, or a case where the two members having a conductive surface are in contact with each other with a conductive material (including a conductive fixed object such as a metal, a conductive adhesive, a conductive oil, or the like) interposed therebetween. The term "integral" includes not only a case where two members having conductive surfaces are connected and fixed to each other with screws or the like, but also a case where the two members are continuously formed of the same material, and for example, a case where the two members are formed by integral molding of metal.

The first member 10 and the second member 20 may be conductive members formed by processing, such as molding or cutting, a conductive metal, or may have a structure in which a conductive film, such as a metal film, formed by plating, coating, surface treatment, or the like is provided on the surface of an insulating member, such as a resin. The ridge 30, the rod 50, and the characteristic adjustment body 60 may be conductive members formed by processing such as molding or cutting a conductive metal, or may have a structure in which a conductive film such as a metal film formed by plating, coating, surface treatment, or the like is provided on a surface of an insulating member such as a resin. The ridge 30, the rod 50, and the characteristic adjustment body 60 may be formed of the same metal. The ridge 30, the rod 50, and the characteristic adjustment body 60 may be formed integrally with the first member 10 as a part of the first member 10, or may be a member separate from the first member 10.

Various dimensions of the ridge 30, the rod 50, and the characteristic adjustment body 60 are defined by the wavelength of the electromagnetic wave transmitted through the ridge waveguide on the ridge 30. Since the effective wavelength of the electromagnetic wave to be transmitted is affected by the dimensions, the shape, and the like of each component and changes in various ways, and is thus difficult to recognize, a representative value of the wavelength of the electromagnetic wave to be transmitted in free space (for example, a wavelength corresponding to the center frequency of the use band (operating frequency band)) is used. This is referred to as a free space wavelength λ₀. The frequency band used in the waveguide device is, for example, a millimeter wave band from 30 GHz to 300 GHz.

The dimensions of the members constituting the waveguide device according to the present disclosure will be described with reference to FIGS. 2B and 2C. A width W1 of the ridge 30 is, for example, λ₀/8. The width W1 is preferably within a range smaller than λ₀/4 and larger than λ₀/16. Widths W2 and W3 of the rod 50 are also λ₀/8, for example. The widths W2 and W3 are also preferably within a range smaller than λ₀/4 and larger than λ₀/16. A width W4 of the characteristic adjustment body 60 is also λ₀/8, for example. The width W4 is also preferably within a range smaller than λ₀/4 and larger than λ₀/16. The widths W1, W2, W3, and W4 may be the same or different.

An arrangement period T1 and an arrangement period T2 of the plurality of rods 50 are, for example, λ₀/4. The arrangement periods T1 and T2 are smaller than λ₀/2, and are preferably within a range of λ₀/4 ± λ₀/8. The arrangement period T1 and the arrangement period T2 may be the same or different. An interval D1 between the ridge 30 and the rod 50 is, for example, λ₀/8. The interval D1 is preferably within a range smaller than λ₀/4 and larger than λ₀/16. An interval D2 and an interval D3 of the plurality of rods 50 are also λ₀/8, for example. The intervals D2 and D3 are also preferably within the range smaller than λ₀/4 and larger than λ₀/16. The interval D1, the interval D2, and the interval D3 may be the same or different.

Heights H of the ridge 30, the rod 50, and the characteristic adjustment body 60 are, for example, larger than the widths W1, W2, W3, and W4, and are, for example, λ₀/4. The height H is smaller than λ₀/2, and is preferably within a range of λ₀/4 ± λ₀/8. The heights of the ridge 30, the rod 50, and the characteristic adjustment body 60 may be the same or different. A length L of the characteristic adjustment body 60 is, for example, λ₀/4, but may be set as appropriate in order to realize desired characteristics.

### Simulation

A simulation was performed on the characteristics of the waveguide device 200 according to the second embodiment. The simulation conditions are as follows.

Center frequency of used band (operating frequency band): 79 GHz

Width W1 of ridge 30: λ₀/8

Length of ridge 30: 3λ₀

Widths W2 and W3 of rod 50: λ₀/8

Interval D1 between ridge 30 and rod 50: λ₀/8

Intervals D2 and D3 of rod 50: λ₀/8

Width W4 of characteristic adjustment body 60: λ₀/8

Length L of characteristic adjustment body 60: λ₀/4

Height H of ridge 30 and rod 50: λ₀/4

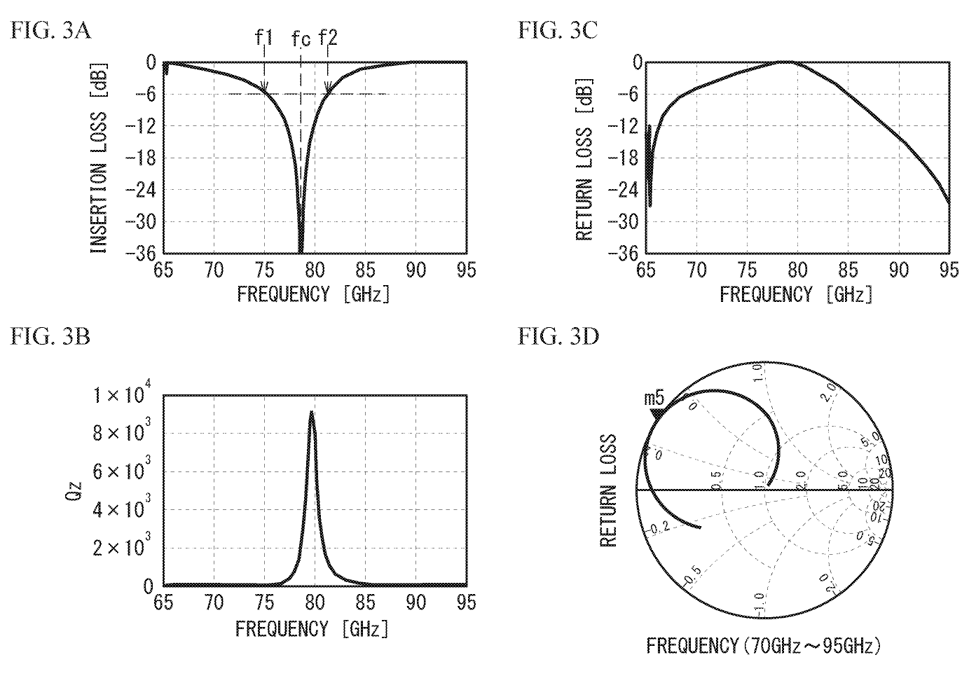

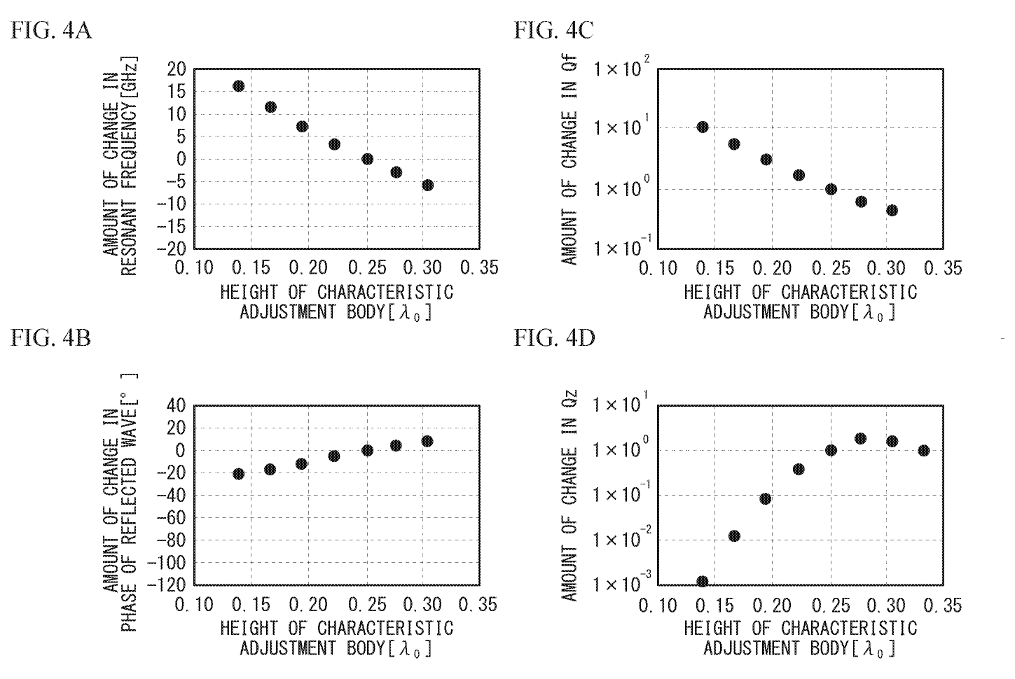

Height H of characteristic adjustment body 60: λ₀/4 in FIGS. 3A to 3D, and change from 0.1λ₀ to 0.35λ₀ in FIGS. 4A to 4D

FIGS. 3A to 3D illustrate simulation results of the waveguide device 200 according to the second embodiment. FIG. 3A illustrates a simulation result of insertion loss with respect to frequency, FIG. 3B illustrates a simulation result of Qz with respect to frequency, FIG. 3C illustrates a simulation result of return loss with respect to frequency, and FIG. 3D illustrates a simulation result of a Smith chart illustrating a reflection characteristic. The insertion loss in FIG. 3A indicates S21. In FIG. 3B, Qz is a parameter indicating the quality of resonance, and is the ratio of an imaginary part to a real part of the impedance of a resonance circuit. The return loss in FIGS. 3C and 3D indicates S11. In FIG. 3D, “m5” is a point of the resonance frequency, and the reflected amount is 1 and the phase is 148 °. In the following description, as illustrated in FIG. 3A, a value (fc/(f2-f1)) obtained by dividing a resonant frequency fc by a difference between frequencies f1 and f2 at which the insertion loss is -6 dB is defined as Qf indicating the quality of the cutoff characteristic.

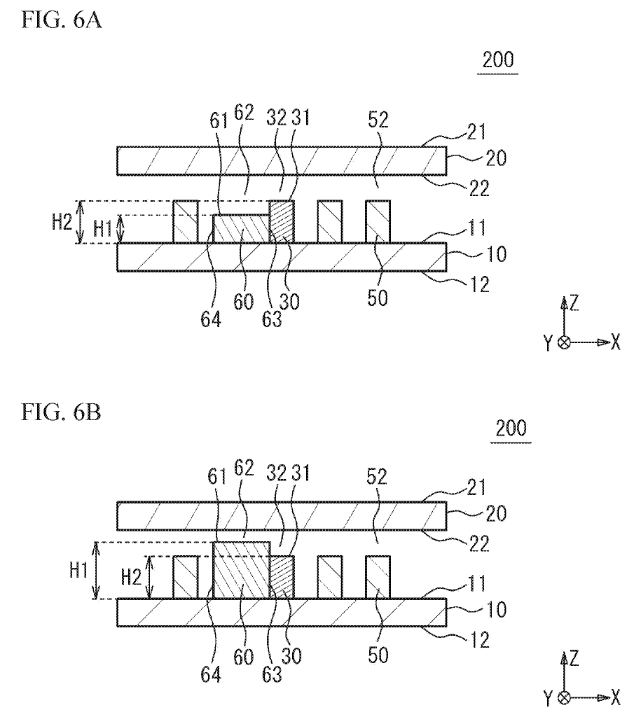

Next, a simulation was performed on the resonance frequency of the waveguide device 200, the phase of the reflected wave, and the amounts of change in Qf and Qz when the height of the characteristic adjustment body 60 in the second embodiment was changed. The change in the height of the characteristic adjustment body 60 in this simulation is illustrated in FIGS. 6A and 6B. FIGS. 6A and 6B are cross-sectional views of the waveguide device 200 according to the second embodiment in which the height of the characteristic adjustment body 60 is changed. As illustrated in FIGS. 6A and 6B, a height H1 of the characteristic adjustment body 60 is different from a height H2 of the ridge 30. FIG. 6A illustrates a case where the height H1 of the characteristic adjustment body 60 is lower than the height H2 of the ridge 30, and FIG. 6B illustrates a case where the height H1 is higher than the height H2. In this simulation, the calculation was performed in the case where the height H1 of the characteristic adjustment body 60 was changed from 0.1λ₀ to 0.35λ₀.

FIGS. 4A to 4D illustrate simulation results when the height of the characteristic adjustment body 60 is changed in the waveguide device 200 according to the second embodiment. FIG. 4A illustrates the simulation result of the amount of change in the resonance frequency with respect to the height of the characteristic adjustment body 60, FIG. 4B illustrates the simulation result of the amount of change in the phase of the reflected wave with respect to the height of the characteristic adjustment body 60, FIG. 4C illustrates the simulation result of the amount of change in Qf with respect to the height of the characteristic adjustment body 60, and FIG. 4D illustrates the simulation result of the amount of change in Qz with respect to the height of the characteristic adjustment body 60. In FIGS. 4A to 4D, the amount of change is calculated with reference to the value when the height of the characteristic adjustment body 60 is 0.25λ₀ (λ₀/4), which is the same as the height of the ridge 30.

As illustrated in FIGS. 4A to 4D, the resonance frequency, the phase of the reflected wave, the value of Qf, and the value of Qz changed as the height of the characteristic adjustment body 60 changed. As illustrated in FIG. 4C, since the value of Qf increases as the characteristic adjustment body 60 becomes lower, it is considered that the cutoff band characteristic of the insertion loss becomes steeper as the characteristic adjustment body 60 becomes lower, and a narrow-band resonance characteristic is obtained. As illustrated in FIG. 4D, since the value of Qz increases as the height of the characteristic adjustment body 60 increases until the height of the characteristic adjustment body 60 reaches about 0.275λ0, it is considered that a broadband resonance characteristic is obtained as the height of the characteristic adjustment body 60 increases. The phase of the reflected wave is the phase of the reflected wave as viewed from an input end of the ridge 30. As described above, since the resonance frequency of the waveguide device 200, the phase of the reflected wave, Qf, and Qz are changed by changing the height of the characteristic adjustment body 60, the characteristics of the waveguide device 200 can be adjusted to desired values by utilizing these.

Next, a simulation was performed on the frequency characteristics when the height of the characteristic adjustment body 60 in the second embodiment was changed. The simulation conditions are the same as the above simulation conditions except that the height of the characteristic adjustment body 60 is set to 0.20λ₀, 0.25λ₀, and 0.30λ₀.

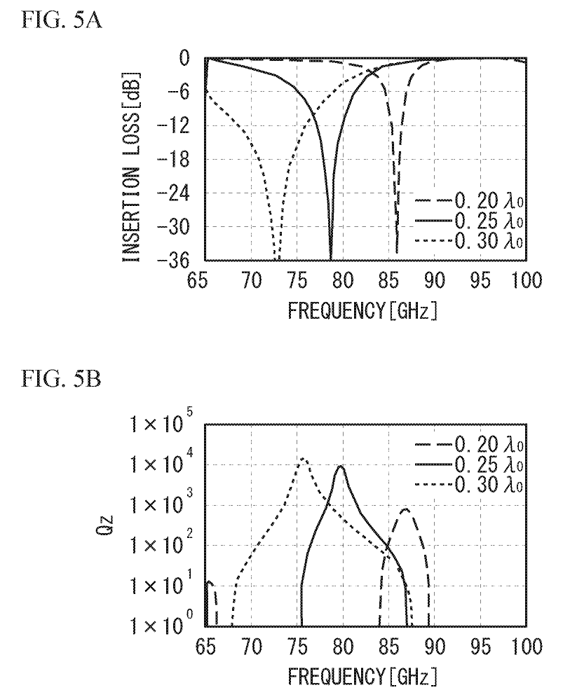

FIGS. 5A and 5B illustrate simulation results of frequency characteristics when the height of the characteristic adjustment body 60 is changed in the waveguide device 200 according to the second embodiment. FIG. 5A illustrates the simulation results of the insertion loss with respect to the frequency, and FIG. 5B illustrates the simulation results of Qz with respect to the frequency. As illustrated in FIGS. 5A and 5B, the resonance frequency changed as the height of the characteristic adjustment body 60 changed. Further, as illustrated in FIG. 5A, the cutoff band characteristic became steeper as the characteristic adjustment body 60 became lower, and as illustrated in FIG. 5B, the value of Qz became larger as the characteristic adjustment body 60 became higher, resulting in a wide-band resonance characteristic. This is consistent with the simulation results of FIGS. 4C and 4D.

In the second embodiment, as illustrated in FIGS. 6A and 6B, the height H1 of the second waveguide surface 61 of the characteristic adjustment body 60 from the upper surface 11 of the first member 10 is different from the height H2 of the first waveguide surface 31 of the ridge 30 from the upper surface 11 of the first member 10. As described above, by adjusting the height H1 of the characteristic adjustment body 60, the optical waveguide device can be adjusted to desired characteristics as illustrated in FIGS. 4A to 5B.

Although FIGS. 6A and 6B illustrate the case where the entire characteristic adjustment body 60 has a height different from that of the ridge 30, the present disclosure is not limited to this case, and a part of the characteristic adjustment body 60 may have a height different from that of the ridge 30. That is, a lowest portion of the second waveguide surface 61 of the characteristic adjustment body 60 may be lower than the first waveguide surface 31 of the ridge 30, or a highest portion of the second waveguide surface 61 of the characteristic adjustment body 60 may be higher than the first waveguide surface 31 of the ridge 30, with respect to the upper surface11 of the first member 10.

### First Modification

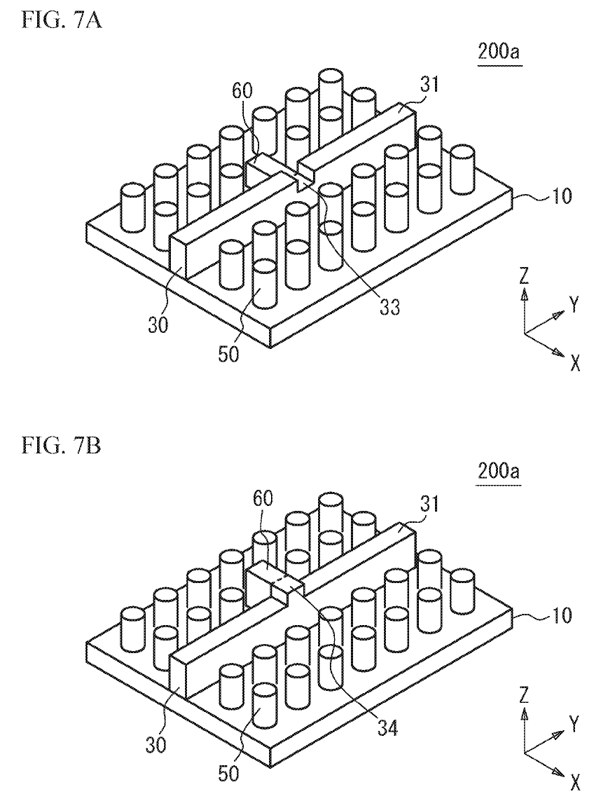

FIGS. 7A and 7B are perspective views of a waveguide device 200a according to a first modification of the second embodiment. As illustrated in FIGS. 7A and 7B, in the waveguide device 200a of the first modification of the second embodiment, the first waveguide surface 31 of the ridge 30 is provided with a recess 33 or a protrusion 34. The characteristic adjustment body 60 is connected to the side of the ridge 30 in the recess 33 or the protrusion 34. In the first modification of the second embodiment, the height of the characteristic adjustment body 60 is the same as the height of the ridge 30 in the recess 33 or the protrusion 34. The other configurations of the first modification of the second embodiment are the same as those of the second embodiment, and thus the description thereof will be omitted.

### Simulation

In the first modification of the second embodiment, a simulation was performed on the characteristics when the height of the characteristic adjustment body 60 and the height of the ridge 30 in the recess 33 or the protrusion 34 were changed together. The simulation conditions other than the height described above are the same as the simulation conditions in FIGS. 3A to 3D of the second embodiment.

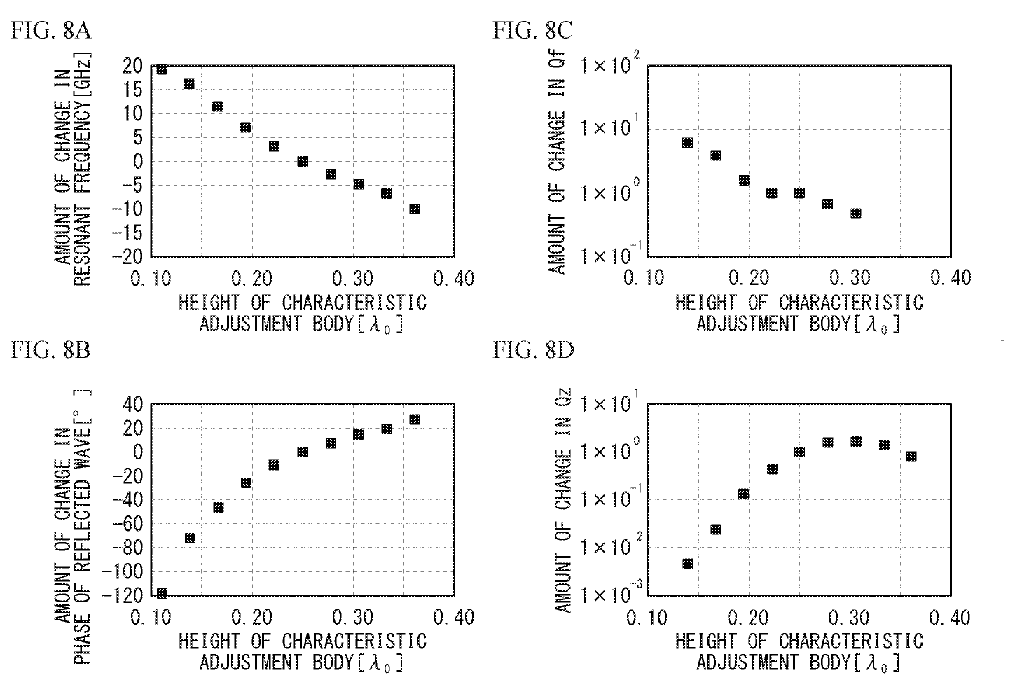

FIGS. 8A to 8D illustrate simulation results when the height of the characteristic adjustment body 60 and the height of the ridge 30 in the recess 33 or the protrusion 34 are changed together in the waveguide device 200a of the first modification of the second embodiment. FIG. 8A illustrates the simulation results of the amount of change in the resonance frequency with respect to the height of the characteristic adjustment body 60, FIG. 8B illustrates the simulation results of the amount of change in the phase of the reflected wave with respect to the height of the characteristic adjustment body 60, FIG. 8C illustrates the simulation results of the amount of change in Qf with respect to the height of the characteristic adjustment body 60, and FIG. 8D illustrates the simulation results of the amount of change in Qz with respect to the height of the characteristic adjustment body 60. In FIGS. 8A and 8B, the amount of change is calculated based on the value when the height of the characteristic adjustment body 60 and the height of the ridge 30 in the recess 33 or the protrusion 34 are 0.25λ₀.

As illustrated in FIGS. 8A to 8D, even when the characteristic adjustment body 60 is connected to the side of the ridge 30 in the recess 33 or the protrusion 34, the resonance frequency, the phase of the reflected wave, the value of Qf, and the value of Qz changed due to the change in the heights of the characteristic adjustment body 60 and the ridge 30 in the recess 33 or the protrusion 34.

According to the first modification of the second embodiment, the ridge 30 has the recess 33 or the protrusion 34 on the first waveguide surface 31, and the characteristic adjustment body 60 is connected to the side of the ridge 30 in the recess 33 or the protrusion 34. Even in such a case, the waveguide device can be adjusted to have desired characteristics as illustrated in FIGS. 8A to 8D by adjusting the heights of the characteristic adjustment body 60 and the ridge 30 in the recess 33 or the protrusion 34.

In the first modification of the second embodiment, the case where the height of the characteristic adjustment body 60 is the same as the height of the ridge 30 in the recess 33 or the protrusion 34 is described as an example, but the height of at least a portion of the characteristic adjustment body 60 may be different from the height of the ridge 30 in the recess 33 or the protrusion 34.

### Second Modification

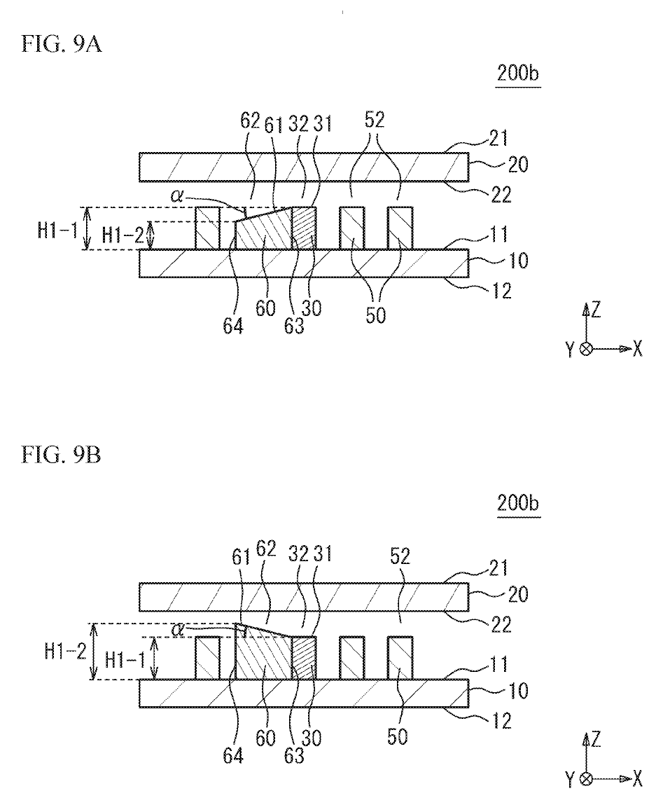

FIGS. 9A and 9B are cross-sectional views of a waveguide device 200b according to a second modification of the second embodiment. As illustrated in FIGS. 9A and 9B, in the waveguide device 200b according to the second modification of the second embodiment, the height of the characteristic adjustment body 60 changes in a slope shape from the end 63 toward the end 64. In FIG. 9A, the characteristic adjustment body 60 has a height H1-2 at the end 64 lower than a height H1-1 at the end 63, and the height is lowered from the end 63 toward the end 64 at an inclination angle α in the slope shape. In FIG. 9B, the characteristic adjustment body 60 has the height H1-2 at the end 64 higher than the height H1-1 at the end 63, and the height increases from the end 63 toward the end 64 at the inclination angle α in the slope shape. The other configurations of the second modification of the second embodiment are the same as those of the second embodiment, and thus the description thereof will be omitted.

### Simulation

In the second modification of the second embodiment, simulations were performed on the characteristics when the height of the characteristic adjustment body 60 was changed by various inclination angles α. The simulation conditions other than the inclination angle α are the same as the simulation conditions in FIGS. 3A to 3D of the second embodiment.

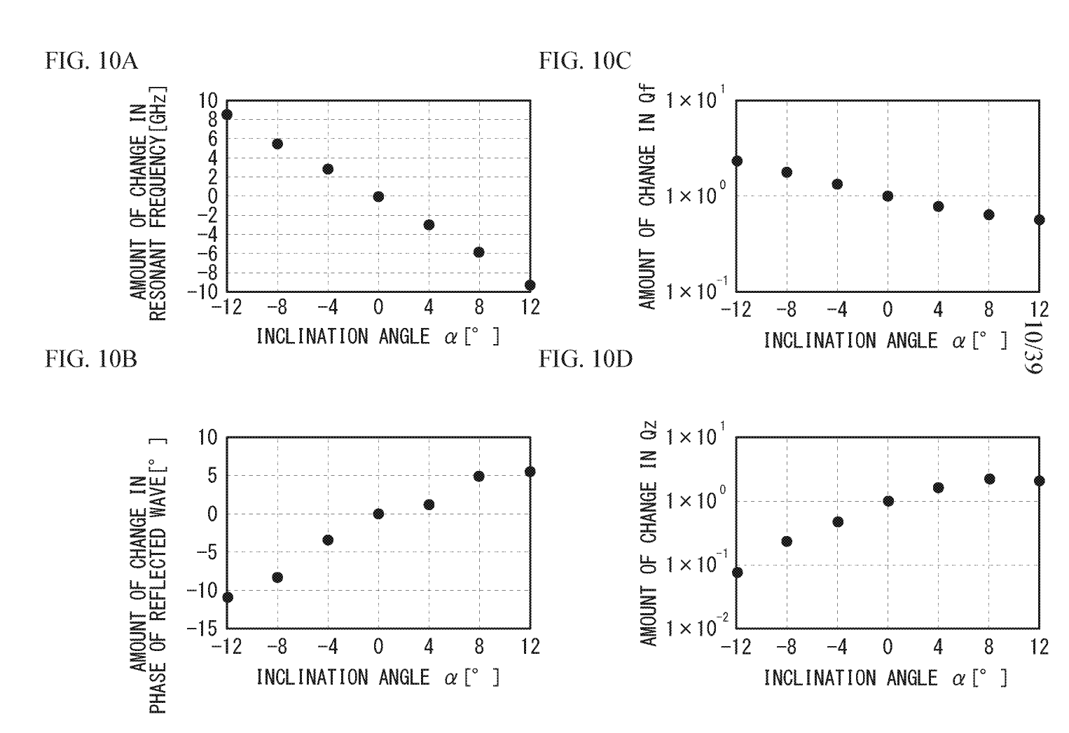

FIGS. 10A to 10D illustrate simulation results when the height of the characteristic adjustment body 60 is changed by various inclination angles α in the waveguide device 200b according to the second modification of the second embodiment. FIG. 10A illustrates a simulation result of the amount of change in the resonance frequency with respect to the inclination angle α, FIG. 10B illustrates a simulation result of the amount of change in the phase of the reflected wave with respect to the inclination angle α, FIG. 10C illustrates a simulation result of the amount of change in Qf with respect to the inclination angle α, and FIG. 10D illustrates a simulation result of the amount of change in Qz with respect to the inclination angle α. In FIGS. 10A to 10D, the amount of change is calculated with reference to the value when the inclination angle α of the characteristic adjustment body 60 is 0 °. Further, as illustrated in FIG. 9A, the inclination angle α in the case where the height H1-2 at the end 64 of the characteristic adjustment body 60 is lower than the height H1-1 at the end 63 is set to be negative, and as illustrated in FIG. 9B, the inclination angle α in the case where the height H1-2 is higher than the height H1-1 is set to be positive.

As illustrated in FIGS. 10A to 10D, the resonance frequency, the phase of the reflected wave, the value of Qf, and the value of Qz changed as the inclination angle α of the characteristic adjustment body 60 changed.

According to the second modification of the second embodiment, the height of the second waveguide surface 61 of the characteristic adjustment body 60 from the upper surface 11 of the first member 10 changes in a sloping manner. At this time, the waveguide device can be adjusted to have desired characteristics by adjusting the inclination angle α of the slope shape.

In the second modification of the second embodiment, the height of the end 63 of the characteristic adjustment body 60 is the same as the height of the ridge 30 at the position where the end 63 is connected, but may be different.

### Third Modification

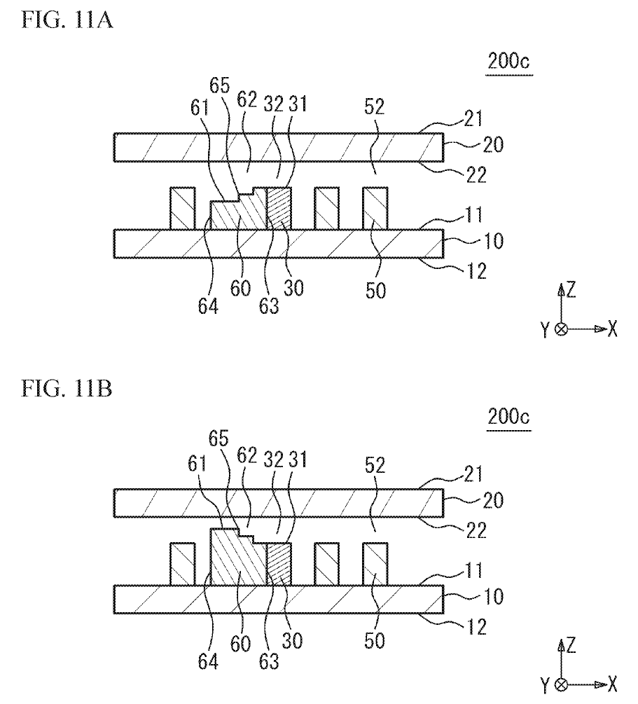

FIGS. 11A and 11B are cross-sectional views of a waveguide device 200c according to a third modification of the second embodiment. As illustrated in FIGS. 11A and 11B, in the waveguide device 200c according to the third modification of the second embodiment, the height of the characteristic adjustment body 60 changes stepwise from the end 63 toward the end 64. In FIG. 11A, the characteristic adjustment body 60 becomes lower stepwise from the end 63 toward the end 64. In FIG. 11B, the characteristic adjustment body 60 becomes higher stepwise from the end 63 toward the end 64. The other configurations of the third modification of the second embodiment are the same as those of the second embodiment, and thus the description thereof will be omitted. Thus, the characteristic adjustment body 60 may include a step portion 65 in the second waveguide surface 61, and the height of the second waveguide surface 61 from the upper surface 11 of the first member 10 may change in a stepwise manner. Even in this case, the waveguide device can be adjusted to have desired characteristics by adjusting the height of the characteristic adjustment body 60. The number of steps of the stairs (step portion 65) can be set freely. The stairs are not limited to a case where the stairs rise or fall from the end 63 toward the end 64, and a stair in which the rise and fall are reversed may be present in the middle. Further, each step may be formed in a slope shape.

In the third modification of the second embodiment, the height of the end 63 of the characteristic adjustment body 60 is the same as the height of the ridge 30 at the position where the end 63 is connected, but may be different.

### Fourth Modification

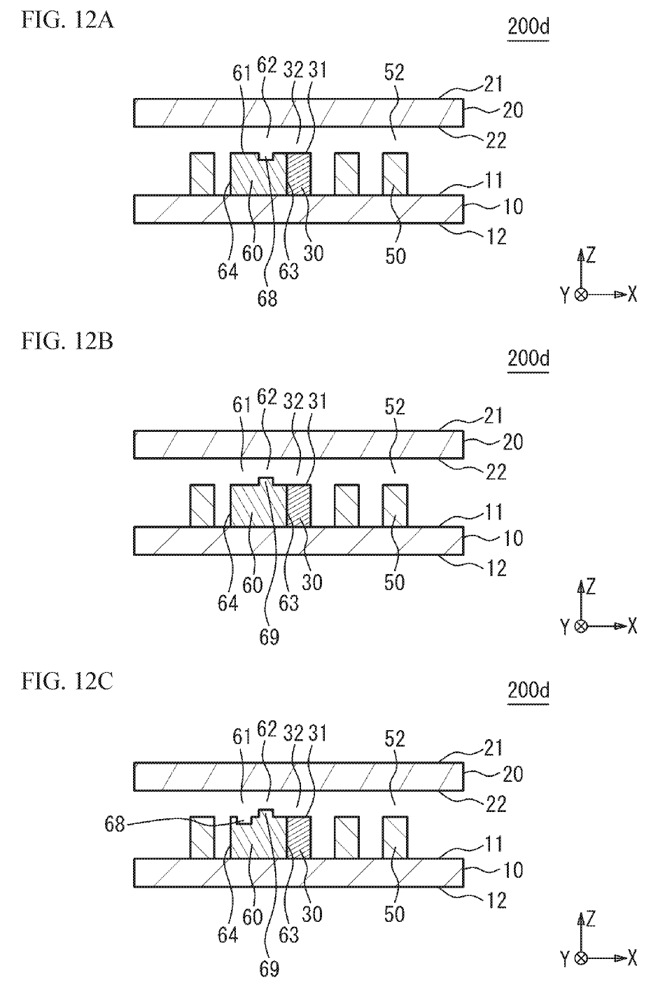

FIGS. 12A to 12C are cross-sectional views of a waveguide device 200d according to a fourth modification of the second embodiment. As illustrated in FIGS. 12A to 12C, in the waveguide device 200d of the fourth modification of the second embodiment, the second waveguide surface 61 of the characteristic adjustment body 60 is provided with a recess 68 and/or a protrusion 69. The other configurations of the fourth modification of the second embodiment are the same as those of the second embodiment, and thus the description thereof will be omitted. Thus, at least one of the recess 68 and the protrusion 69 may be provided on the second waveguide surface 61 of the characteristic adjustment body 60. Even in this case, the waveguide device can be adjusted to have desired characteristics by adjusting the height of the characteristic adjustment body 60. The characteristic adjustment body 60 may include the step portion 65 of the third modification in addition to at least one of the recess 68 and the protrusion 69.

### Fifth Modification

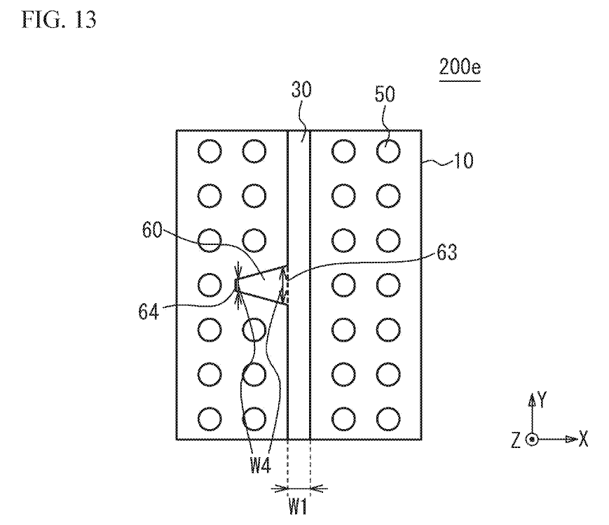

FIG. 13 is a plan view of a waveguide device 200e according to a fifth modification of the second embodiment. As illustrated in FIG. 13, in the waveguide device 200e according to the fifth modification of the second embodiment, the width of the characteristic adjustment body 60 at the end 63 is larger than the width at the end 64 in planar view. For example, the characteristic adjustment body 60 has a width that is narrowed in a tapered shape from the end 63 toward the end 64. The width W4 of the characteristic adjustment body 60 near the end 63 is larger than the width W1 of the ridge 30, for example. The width W4 of the characteristic adjustment body 60 near the end 64 is smaller than the width W1 of the ridge 30, for example. That is, the characteristic adjustment body 60 may include a portion larger than the width W1 of the ridge 30 as the width W4 of the characteristic adjustment body 60, or may include a portion smaller than the width W1 of the ridge 30. The width W4 is a width between two side surfaces of the characteristic adjustment body 60 in a longitudinal direction. The width W1 is a width between two side surfaces of the ridge 30 in the longitudinal direction. The other configurations of the fifth modification of the second embodiment are the same as those of the second embodiment, and thus the description thereof will be omitted. As described above, the characteristic adjustment body 60 may have the width at the end 63 larger than the width at the end 64. With such a structure, the area of the second waveguide surface 61 of the characteristic adjustment body 60 that is substantially parallel to the lower surface 22 of the second member 20 changes compared to the case where the width at the end 63 and the width at the end 64 are the same, and therefore the waveguide device can be adjusted to desired characteristics.

### Sixth Modification

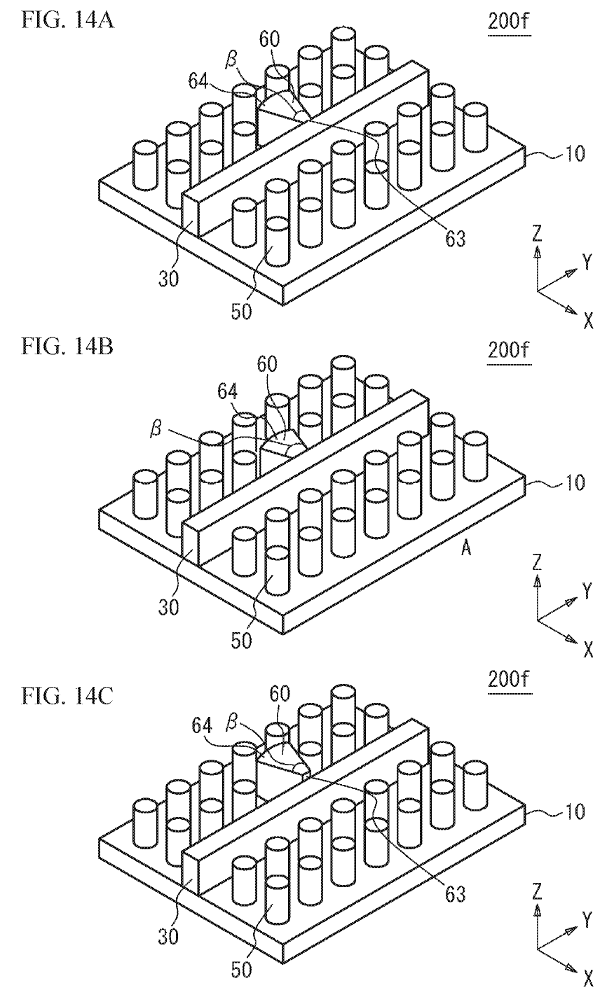

FIGS. 14A to 14C are perspective views of a waveguide device 200f according to a sixth modification of the second embodiment. As illustrated in FIGS. 14A to 14C, in the waveguide device 200f of the sixth modification of the second embodiment, the characteristic adjustment body 60 has a shape that spreads in a fan shape from the end 63 to the end 64 in planar view. A central angle of the fan shape is β. The height of the characteristic adjustment body 60 may be the same as the height of the ridge 30 as illustrated in FIG. 14A, or may be different from the height of the ridge 30 as illustrated in FIGS. 14B and 14C. The other configurations of the sixth modification of the second embodiment are the same as those of the second embodiment, and thus the description thereof will be omitted.

### Simulation

In the sixth modification of the second embodiment, simulations were performed on the characteristics when the central angle β of the characteristic adjustment body 60 was changed and the characteristics when the height of the characteristic adjustment body 60 was changed. When the central angle β was changed, the height of the characteristic adjustment body 60 was made the same as the height of the ridge 30. When the height of the characteristic adjustment body 60 was changed, the central angle β was fixed to 45 °. The other simulation conditions of the sixth modification of the second embodiment are the same as the simulation conditions in FIGS. 3A to 3D of the second embodiment.

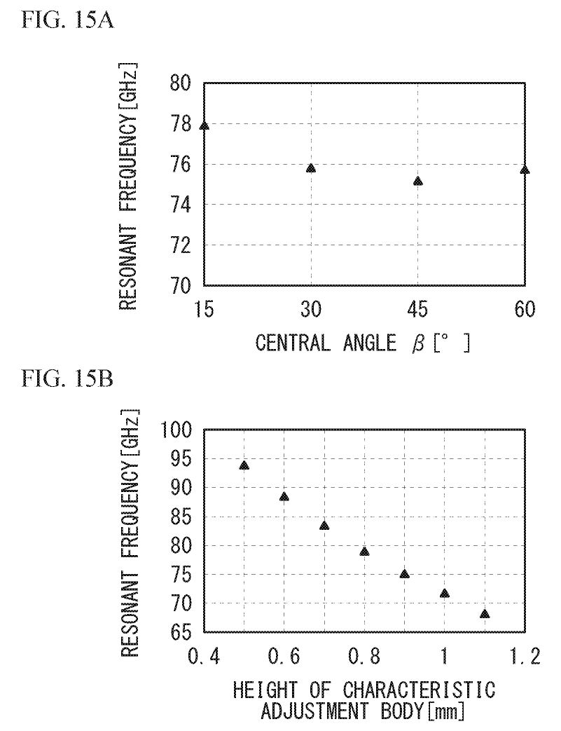

FIG. 15A illustrates simulation results when the central angle β of the characteristic adjustment body 60 is changed in the waveguide device 200f of the sixth modification of the second embodiment, and FIG. 15B illustrates simulation results when the height of the characteristic adjustment body 60 is changed. As illustrated in FIG. 15A, the value of the resonance frequency changed as the central angle β of the characteristic adjustment body 60 changed. This is thought to be due to the fact that the area of the second waveguide surface 61 of the characteristic adjustment body 60 that was substantially parallel to the lower surface 22 of the second member 20 changed as a result of the central angle β changed. As illustrated in FIG. 15B, even when the characteristic adjustment body 60 has the fan shape, the resonance frequency changed as the height of the characteristic adjustment body 60 changed.

In the sixth modification of the second embodiment, the characteristic adjustment body 60 has a fan shape in planar view. At this time, by adjusting the central angle β of the fan shape, the waveguide device can be adjusted to have desired characteristics as illustrated in FIG. 15A.

### Seventh Modification

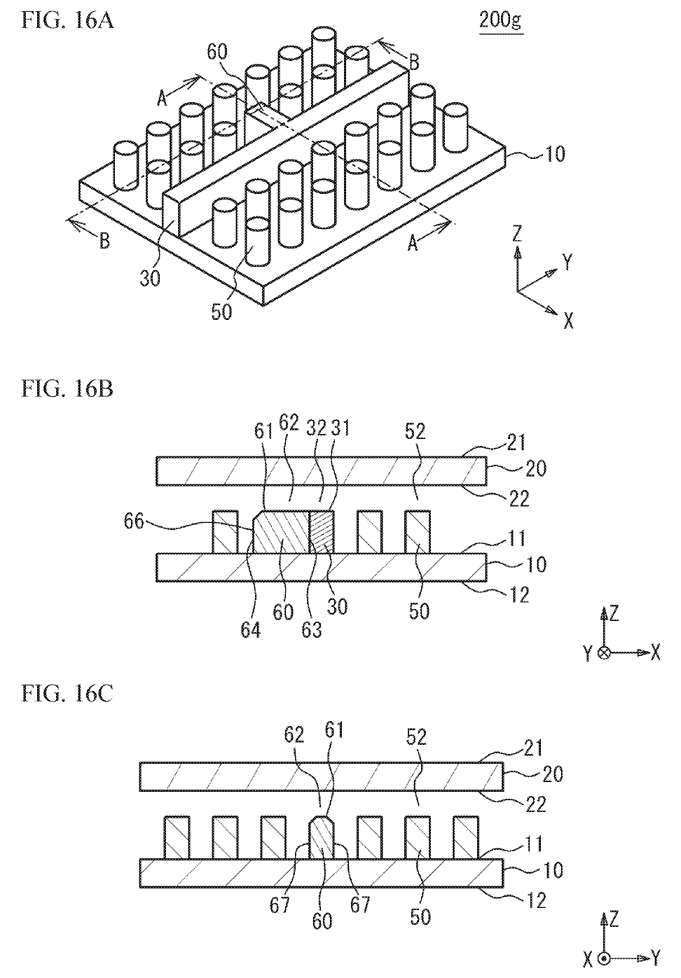

FIG. 16A is a perspective view of a waveguide device 200g according to a seventh modification of the second embodiment, and FIGS. 16B and 16C are cross-sectional views taken along line A-A and line B-B in FIG. 16A, respectively. In FIG. 16A, chamfering of the corners of the second waveguide surface 61 is not illustrated for the sake of clarity. As illustrated in FIGS. 16A to 16C, in the waveguide device 200g of the seventh modification of the second embodiment, the corners of the second waveguide surface 61 of the characteristic adjustment body 60 are chamfered. For example, the second waveguide surface 61 has a flat face with C-chamfered corners. The other configurations of the seventh modification of the second embodiment are the same as those of the second embodiment, and thus the description thereof will be omitted.

As in the seventh modification of the second embodiment, at least one of a boundary between the second waveguide surface 61 and a side surface 67 of the characteristic adjustment body 60 and a boundary between the second waveguide surface 61 and a tip surface 66 of the end 64 may be chamfered. This changes the area of the second waveguide surface 61 of the characteristic adjustment body 60 that is substantially parallel to the lower surface 22 of the second member 20, thereby enabling the waveguide device to be tuned to desired characteristics. The chamfering is not limited to C-chamfering, and may be R-chamfering.

### Eighth Modification

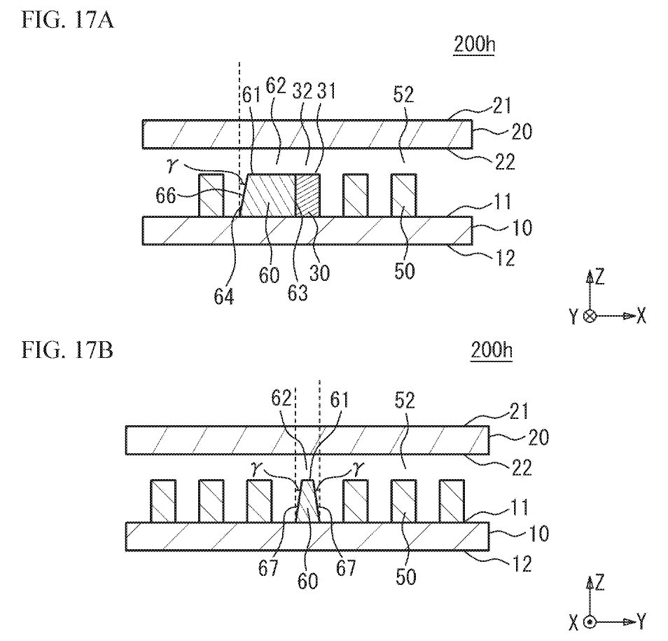

FIGS. 17A and 17B are cross-sectional views of a waveguide device 200h according to an eighth modification of the second embodiment. As illustrated in FIGS. 17A and 17B, in the waveguide device 200h according to the eighth modification of the second embodiment, the tip surface 66 of the end 64 of the characteristic adjustment body 60 is a forward-tapered inclined surface with respect to the upper surface 11 of the first member 10. Both side surfaces 67 of the characteristic adjustment body 60 are also forward-tapered inclined surfaces with respect to the upper surface 11 of the first member 10. The inclination angle of the tip surface 66 and the side surfaces 67 with respect to the normal line of the upper surface 11 of the first member 10 is denoted by γ. The other configurations of the eighth modification of the second embodiment are the same as those of the second embodiment, and thus the description thereof will be omitted.

### Simulation

The characteristics of the following models A, B, and C were simulated when the inclination angle γ was changed. The simulation conditions other than the change in the inclination angle γ are the same as the simulation conditions in FIGS. 3A to 3D of the second embodiment.

Model A: The tip surface 66 and both side surfaces 67 of the characteristic adjustment body 60 are inclined surfaces.

Model B: Both side surfaces 67 of the characteristic adjustment body 60 are inclined surfaces, and the tip surface 66 is a vertical surface.

Model C: The tip surface 66 of the characteristic adjustment body 60 is an inclined surface, and both side surfaces 67 are vertical surfaces.

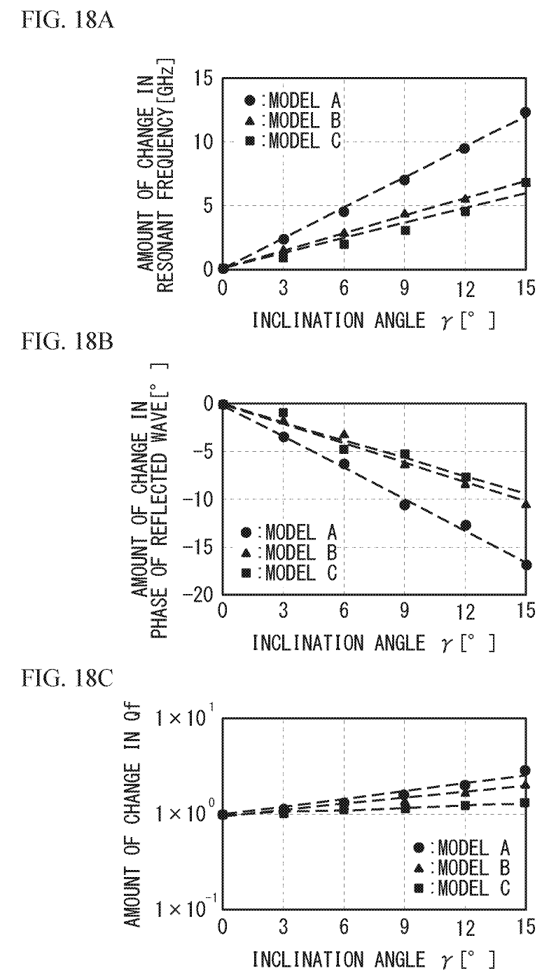

FIGS. 18A to 18C are simulation results of the models A, B, and C. FIG. 18A illustrates a simulation result of the amount of change in the resonance frequency with respect to the inclination angle γ, FIG. 18B illustrates a simulation result of the amount of change in the phase of the reflected wave with respect to the inclination angle γ, and FIG. 18C illustrates a simulation result of the amount of change in Qf with respect to the inclination angle γ. In FIGS. 18A to 18C, the amount of change is calculated with reference to the value when the inclination angle γ is 0 °.

As illustrated in FIGS. 18A to 18C, in all of the models A, B, and C, the resonance frequency, the phase of the reflected wave, and the value of Qf changed as the inclination angle γ of the characteristic adjustment body 60 changed. The amount of change in the resonance frequency, the amount of change in the phase of the reflected wave, and the amount of change in the value of Qf were larger in the model A in which both the tip surface 66 and the side surface 67 were the inclined surfaces than in the model B in which only the side surface 67 was the inclined surface and the model C in which only the tip surface 66 was the inclined surface. The model B in which only the side surface 67 was the inclined surface had a larger amount of change in the resonance frequency, a larger amount of change in the phase of the reflected wave, and a larger amount of change in the value of Qf than the model C in which only the tip surface 66 was inclined surface. The reason why the characteristics such as the resonance frequency were changed by changing the inclination angle γ of the tip surface 66 and/or the side surfaces 67 is thought to be that the area of the second waveguide surface 61 of the characteristic adjustment body 60 that was substantially parallel to the lower surface 22 of the second member 20 was changed.

In the eighth modification of the second embodiment, at least one of the tip surface 66 and the side surfaces 67 of the characteristic adjustment body 60 is the inclined surface. In this case, the waveguide device can be adjusted to have desired characteristics by adjusting the inclination angle γ of the tip surface 66 and the side surfaces 67. In addition, when the characteristic adjustment body 60 is formed by molding with a mold, the characteristic adjustment body 60 can be easily taken out from the mold because the characteristic adjustment body 60 has the inclined surface.

In the eighth modification of the second embodiment, the inclination angle of the tip surface 66 and the inclination angle of the side surfaces 67 are the same, but may be different from each other. Further, the inclination angles of both side surfaces 67 may be different from each other. Only one of the side surfaces 67 may be the inclined surface.

Next, in the ninth to seventeenth modifications, an arrangement example of the rods 50 and an example of a case where a post 70, or a wall portion 80 or 80a is provided in place of some rods 50 will be described.

### Ninth, Tenth and Eleventh Modifications

FIG. 19A is a plan view of a waveguide device 200i according to a ninth modification of the second embodiment, and FIG. 19B is a plan view of a waveguide device 200j according to a tenth modification of the second embodiment. As illustrated in FIG. 19A, in the waveguide device 200i according to the ninth modification of the second embodiment, the rod 50 is not provided in front of the end 64 of the characteristic adjustment body 60. The other configurations of the ninth modification of the second embodiment are the same as those of the second embodiment, and thus the description thereof will be omitted.

As illustrated in FIG. 19B, in the waveguide device 200j according to the tenth modification of the second embodiment, among the plurality of rods 50 provided around the ridge 30 and the characteristic adjustment body 60, the rods 50 other than the one or more rods 50a located in front of the end 64 of the characteristic adjustment body 60 are regularly disposed, and the rods 50a located in front of the end 64 are disposed out of the regularity. The other configurations of the tenth modification of the second embodiment are the same as those of the second embodiment, and thus the description thereof will be omitted.

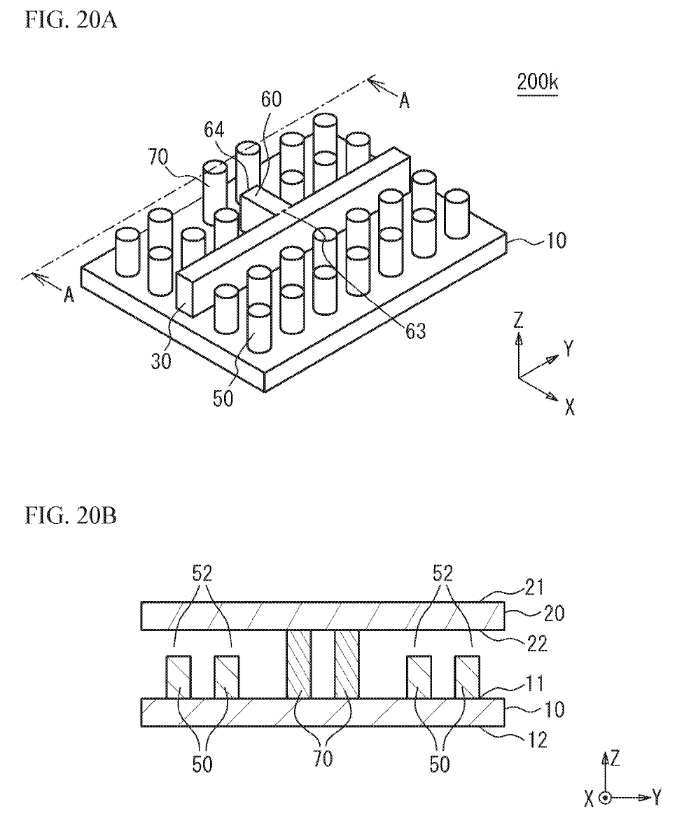

FIG. 20A is a perspective view of a waveguide device 200k according to an eleventh modification of the second embodiment, and FIG. 20B is a cross-sectional view taken along a line A-A in FIG. 20A. As illustrated in FIGS. 20A and 20B, in the waveguide device 200k according to the eleventh modification of the second embodiment, the rod 50 is not provided in front of the end 64 of the characteristic adjustment body 60, and instead, one or more posts 70 are provided in which the end of each of the posts 70 in the -Z direction is in contact with the upper surface 11 of the first member 10 and the end of each of the posts 70 in the +Z direction is in contact with the lower surface 22 of the second member 20. The posts 70 are provided, for example, out of the regularity of the plurality of rods 50, similarly to the rods 50a. The other configurations of the eleventh modification of the second embodiment are the same as those of the second embodiment, and thus the description thereof will be omitted.

### Simulation

The insertion loss of the waveguide devices 200i to 200k according to the ninth to eleventh modifications of the second embodiment was simulated. For comparison, the simulation results of the insertion loss of the waveguide device 200 according to the second embodiment are also illustrated. The simulation conditions are the same as the simulation conditions in FIGS. 3A to 3D of the second embodiment except for the following points. An interval L1 in the following description is an interval between an imaginary straight line “m” extending in the surface direction of the tip surface at the end 64 of the characteristic adjustment body 60 and the center of the rod 50a in planar view as illustrated in FIG. 19B. An interval L2 is an interval between an imaginary straight line “n” passing through the center of the characteristic adjustment body 60 in the width direction and the center of the rod 50a.

Center frequency of used band (operating frequency band): 81 GHz

Interval L1 in rod 50a or post 70: λ₀/8

Interval L2 in rod 50a or post 70: λ₀/8

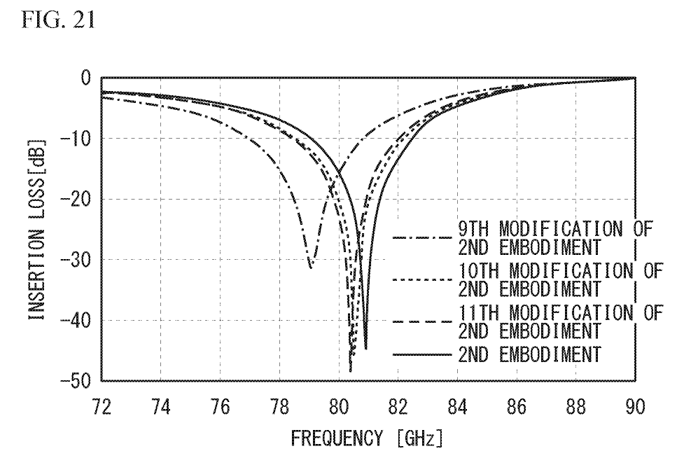

FIG. 21 illustrates simulation results of the insertion loss of the waveguide devices according to the second embodiment and the ninth to eleventh modifications of the second embodiment. As illustrated in FIG. 21, the resonant frequencies of the ninth to eleventh modifications of the second embodiment are changed compared to the second embodiment. This illustrates that the resonance frequency can be controlled by the presence or absence of the rod in front of the end 64 of the characteristic adjustment body 60, the position of the rod, and the provision of the post instead of the rod.

According to the ninth modification of the second embodiment, as illustrated in FIG. 19A, the rod 50 is not provided in front of the end 64 of the characteristic adjustment body 60. According to the tenth modification of the second embodiment, as illustrated in FIG. 19B, one or more rods 50a located in front of the end 64 of the characteristic adjustment body 60 are located out of the regularity of the rods 50 other than the rods 50a. According to the eleventh modification of the second embodiment, as illustrated in FIGS. 20A and 20B, one or more posts 70 that contact the first member 10 and the second member 20 are provided in front of the characteristic adjustment body 60. With these, as illustrated in FIG. 21, the resonance frequency can be changed, and therefore, the waveguide device can be adjusted to desired characteristics by controlling the presence or absence, the position, and/or the height of the rods in front of the end 64 of the characteristic adjustment body 60.

### Twelfth, Thirteenth, and Fourteenth Modifications

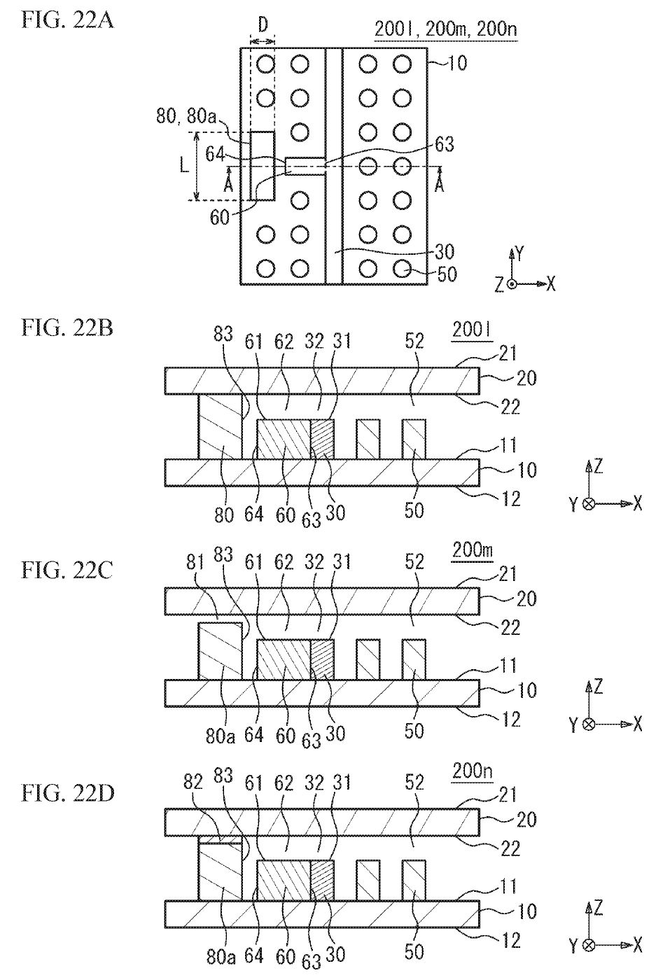

FIG. 22A is a plan view of waveguide devices 200l, 200m, and 200n according to twelfth, thirteenth, and fourteenth modifications of the second embodiment. FIG. 22B is a cross-sectional view of the waveguide device 200l according to the twelfth modification of the second embodiment. FIG. 22C is a cross-sectional view of the waveguide device 200m according to the thirteenth modification of the second embodiment. FIG. 22D is a cross-sectional view of the waveguide device 200n according to the fourteenth modification of the second embodiment.

As illustrated in FIGS. 22A and 22B, in the waveguide device 200l of the twelfth modification of the second embodiment, the rod 50 is not provided in front of the end 64 of the characteristic adjustment body 60, and the wall portion 80 is provided instead. The wall portion 80 has a side surface 83 with conductivity facing at least the end 64, and extends in the Y direction along the tip surface of the end 64 of the characteristic adjustment body 60. At least the side surface 83 of the wall portion 80 has an end in the -Z direction in contact with the upper surface 11 of the first member 10 and an end in the +Z direction in contact with the lower surface 22 of the second member 20. The wall portion 80 extending along the tip surface of the end 64 of the characteristic adjustment body 60 is not limited to a case where the wall portion 80 is completely parallel to the tip surface, and includes a case where the wall portion 80 is inclined. The length L of the wall portion 80 can be selected from various sizes, but is preferably larger than a gap between the upper surface 11 of the first member 10 and the lower surface 22 of the second member 20 at the position of the wall portion 80, for example, and is preferably λ₀/2 or more, for example. A width D of the wall portion 80 is equal to or larger than λ₀/4, and is, for example, equal to or larger than the width of the rod 50. The other configurations of the twelfth modification of the second embodiment are the same as those of the second embodiment, and thus the description thereof will be omitted.

As illustrated in FIGS. 22A and 22C, in the waveguide device 200m according to the thirteenth modification of the second embodiment, the wall portion 80a is provided in front of the end 64 of the characteristic adjustment body 60. The end of the wall portion 80a in the -Z direction is in contact with the upper surface 11 of the first member 10, but the end in the +Z direction is not in contact with the lower surface 22 of the second member 20 and is separated from the lower surface 22. An air gap 81 is formed between the wall portion 80a and the lower surface 22 of the second member 20. The height of the air gap 81 may be, for example, half or less, or one-fourth or less of the height of the first air gap 32. The other configurations of the thirteenth modification of the second embodiment are the same as those of the twelfth modification of the second embodiment, and thus the description thereof is omitted.

As illustrated in FIGS. 22A and 22D, in the waveguide device 200n according to the fourteenth modification of the second embodiment, the wall portion 80a is provided in front of the end 64 of the characteristic adjustment body 60. A dielectric film 82 is provided between the wall portion 80a and the lower surface 22 of the second member 20. The thickness of the dielectric film 82 may be, for example, less than or equal to half of the height of the first air gap 32, or less than or equal to one-fourth of the height of the first air gap 32. The other configurations of the fourteenth modification of the second embodiment are the same as those of the thirteenth modification of the second embodiment, and thus the description thereof is omitted.

In the twelfth modification of the second embodiment, the wall portion 80 is in contact with the upper surface 11 of the first member 10 and the lower surface 22 of the second member 20. Therefore, the wall portion 80 is electrically conductive to the upper surface 11 of the first member 10 and the lower surface 22 of the second member 20, and the wall portion 80 functions as an electrical wall. In the thirteenth and fourteenth modifications of the second embodiment, the wall portion 80a is separated from the lower surface 22 of the second member 20, and the air gap 81 or the dielectric film 82 is formed between the wall portion 80a and the second member 20. Therefore, the wall portion 80a and the lower surface 22 of the second member 20 are not in direct conductive contact. However, the wall portion 80a and the lower surface 22 of the second member 20 are high-frequency coupled to each other in the use frequency band and are in a conductive state with each other. In this specification, this is referred to as a "high-frequency coupling" state. Therefore, the wall portion 80a functions as the electric wall. The gap between the wall portion 80a and the lower surface 22 of the second member 20 is, for example, 100 μm or less or 50 μm or less. A gap at which the high-frequency coupling state occurs depends on at least the areas of the two conductive surfaces facing each other with the gap interposed therebetween. Therefore, even when two members having conductive surfaces are arranged with an air gap of 100 μm or more, for example, whether or not the two members are in the high-frequency coupling state depends on the structure at that time. Therefore, in a case where the upper surface of the wall portion 80 also has conductivity, the high-frequency coupling state may be obtained even when the air gap is larger than in a case where the upper surface of the wall portion 80 has not conductivity. This can be determined from the result of electromagnetic simulation in the design stage.

According to the twelfth, thirteenth, and fourteenth modifications of the second embodiment illustrated in FIGS. 22A to 22D, the wall portion 80 or 80a are provided adjacent to the characteristic adjustment body 60 without the rod 50 interposed therebetween and in contact with or high-frequency coupled to the upper surface 11 of the first member 10 and the lower surface 22 of the second member 20. The wall portion 80 or 80a has conductivity at least on the side surface 83 facing the characteristic adjustment body 60. By providing the wall portion 80 or 80a adjacent to the characteristic adjustment body 60, the wall portion 80 or 80a functions as the electric wall, thereby obtaining a good shielding effect of the electromagnetic wave, and adjusting the characteristics of the wave guide device to desired characteristics. In addition, in the case of using the wall portion 80, the height of the second air gap 62 of the characteristic adjustment body 60 is defined by the wall portion 80, and thus the height of the second air gap 62 can be accurately adjusted to a desired height.

The posts 70 illustrated in FIGS. 20A and 20B are not limited to being in contact with the upper surface 11 of the first member 10 and the lower surface 22 of the second member 20, and may be high-frequency coupled to the upper surface 11 of the first member 10 and the lower surface 22 of the second member 20, similarly to the wall portion 80a.

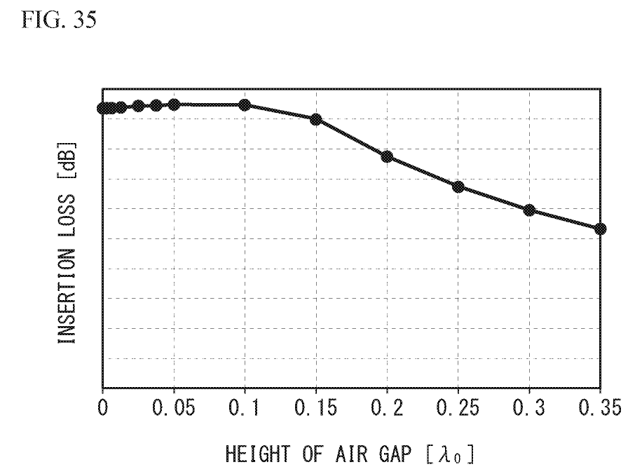

FIG. 35 illustrates the simulation results when the height of the air gap 81 is changed in a waveguide device 200m illustrated in FIG. 22C. As illustrated in FIG. 35, it can be seen that the insertion loss deteriorates as the height of the air gap 81 increases, but when the height of the air gap 81 is sufficiently small with respect to the wavelength, the insertion loss can be suppressed to a deterioration that does not interfere with the ability to block the propagation of the electromagnetic wave even when the wall portion 80a is not in contact with the second member 20. As described above, even when the wall portion 80a is not in contact with the second member 20, if the reduction in the insertion loss due to the air gap 81 is within a range that is allowable in the intended use, it can be said that the wall portion 80a and the second member 20 are in the high-frequency coupling state. The reduction in the insertion loss varies depending on the characteristics expected for the waveguides, such as the facing area and the gap between the wall portion 80a and the second member 20, the use application, and the required performance.

### Fifteenth, Sixteenth and Seventeenth Modifications

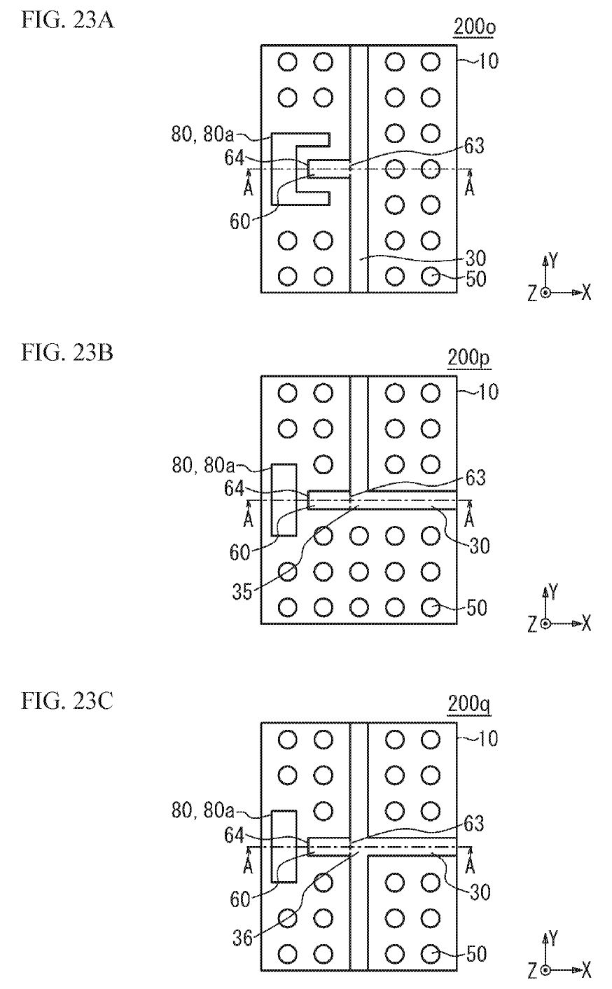

FIG. 23A is a plan view of a waveguide device 200o according to a fifteenth modification of the second embodiment. FIG. 23B is a plan view of a waveguide device 200p according to a sixteenth modification of the second embodiment. FIG. 23C is a plan view of a waveguide device 200q according to a seventeenth modification of the second embodiment. As illustrated in FIG. 23A, in the waveguide device 200o of the fifteenth modification of the second embodiment, the wall portion 80 or 80a has a U-shape extending from the front to the sides of the end 64 of the characteristic adjustment body 60. In this way, the wall portion 80 or 80a extends from the front of the end 64 of the characteristic adjustment body 60 to the sides of the characteristic adjustment body 60, so that the shielding effect of the electromagnetic wave is further improved.

As illustrated in FIG. 23B, the ridge 30 of the waveguide device 200p according to the sixteenth modification of the second embodiment has a bent portion 35 bent in an L-shape. The characteristic adjustment body 60 is connected to the side of the ridge 30 at the bent portion 35. As illustrated in FIG. 23C, in the waveguide device 200q of the seventeenth modification of the second embodiment, the ridge 30 has a T-shaped branched portion 36. The characteristic adjustment body 60 is connected to the side of the ridge 30 at the branched portion 36. In this manner, the end 63 of the characteristic adjustment body 60 is connected to the side of the ridge 30 at the bent portion 35 or the branched portion 36 of the ridge 30. The ridge 30 changes in impedance at the bent portion 35 and the branched portion 36. By connecting the characteristic adjustment body 60 to the bent portion 35 or the branched portion 36, the impedance at the bent portion 35 or the branched portion 36 can be matched with the impedance at a linear portion in the ridge 30.

### Third Embodiment

Third embodiment is an example of a case where a characteristic adjustment body 60a is provided on the upper surface 11 of the first member 10, the characteristic adjustment body 60a having one end 63a connected to a side of the ridge 30 and being in contact with or high-frequency coupled to the lower surface 22 of the second member 20 by a conductor 72a. FIG. 24A is a plan view of a waveguide device 300 according to a third embodiment, and FIGS. 24B and 24C are cross-sectional views taken along lines A-A and B-B in FIG. 24A, respectively.

As illustrated in FIGS. 24A to 24C, the characteristic adjustment body 60a having a conductive upper surface is provided between the upper surface 11 of the first member 10 and the lower surface 22 of the second member 20. The end 63a of the characteristic adjustment body 60a in the +X direction is connected to the side of the ridge 30, and as one example, the conductor 72a at the end in the -X direction has conductivity at least on the side surface thereof and is in contact with or high-frequency coupled to the upper surface of the characteristic adjustment body 60a and the lower surface 22 of the second member 20. Note that the upper surface of the conductor 72a may also have conductivity. The conductor 72a does not need to be located at the end of the characteristic adjustment body 60a in the -X direction, and may be disposed at any position as long as the structure allows conduction between at least the upper surface of the characteristic adjustment body 60a and the lower surface 22 of the second member 20. Further, the cross section of the conductor 72a may be thickened to such an extent that the upper surface of the characteristic adjustment body 60a is covered. In this embodiment, for the sake of simplicity, an example in which the conductor 72a is disposed at an end of the characteristic adjustment body 60a will be described. The end of the characteristic adjustment body 60a in the +Z direction is not in contact with the lower surface 22 of the second member 20 except for the conductor 72a, and is separated from the lower surface 22 of the second member 20. The characteristic adjustment body 60a may have any shape. The upper surface (the end surface on the +Z direction side) of the characteristic adjustment body 60a that faces the lower surface 22 of the second member 20 serves as a second waveguide surface 61a with conductivity. A second air gap 62a is formed between the lower surface 22 of the second member 20 and the second waveguide surface 61a of the characteristic adjustment body 60a. A waveguide through which the electromagnetic wave is transmitted is formed in the second air gap 62a. The other configurations of the third embodiment are the same as those of the first embodiment, and thus the description thereof will be omitted.

According to the third embodiment, the characteristic adjustment body 60a having the second waveguide surface 61a with conductivity that faces the lower surface 22 of the second member 20 with the second air gap 62a interposed therebetween is disposed on the upper surface11 of the first member 10. The characteristic adjustment body 60a has one end 63a connected to a side of the ridge 30, and is in contact with or high-frequency coupled to the lower surface 22 of the second member 20 by the conductor 72a. The characteristics of the waveguide device are changed by providing the characteristic adjustment body 60a as described below. By predicting this by simulation in the design stage and providing the characteristic adjustment body having the predetermined shape, the waveguide device can be adjusted to desired characteristics.

### Fourth Embodiment

In a fourth embodiment, various examples of a waveguide device including the characteristic adjustment body 60a will be described. FIG. 25A is a perspective view of a waveguide device 400 according to the fourth embodiment, FIG. 25B is a plan view of the waveguide device 400 according to the fourth embodiment, and FIG. 25C is a cross-sectional view taken along a line A-A in FIG. 25B. As illustrated in FIGS. 25A to 25C, the waveguide device 400 according to the fourth embodiment includes the characteristic adjustment body 60a in which the end 63a is connected to the side of the ridge 30, and the conductor 72a has conductivity at least on a side surface thereof and is in contact with or high-frequency coupled to the upper surface of the characteristic adjustment body 60a and the lower surface 22 of the second member 20, similarly to the waveguide device 300 according to the third embodiment. Note that the upper surface of the conductor 72a may also have conductivity. As described above, the conductor 72a does not need to be located at the end of the characteristic adjustment body in the -X direction, and does not need to have a flat shape illustrated in FIGS. 25A, 25B, and 25C. The characteristic adjustment body 60a has a rectangular parallelepiped shape except for the conductor 72a that is in contact with or high-frequency coupled to the lower surface 22 of the second member 20. The other configurations of the fourth embodiment are the same as those of the third embodiment, and thus the description thereof will be omitted.

### Simulation

A simulation was performed on the characteristics when the height H of the characteristic adjustment body 60a in the fourth embodiment was changed. The simulation conditions are as follows.

Center frequency of used band (operating frequency band): 81 GHz

Width of ridge 30: λ0/8

Length of ridge 30: 3λ0

Width of rod 50: λ0/8

Interval between ridge 30 and rod 50: λ0/8

Interval between rods 50: λ0/8

Width of characteristic adjustment body 60a: λ0/8

Length of characteristic adjustment body 60a: λ0/4

Height of ridge 30 and rod 50: λ0/4

Height of characteristic adjustment body 60a: 0.15λ0, 0.20λ0, 0.25λ0, 0.30λ0, 0.35λ0

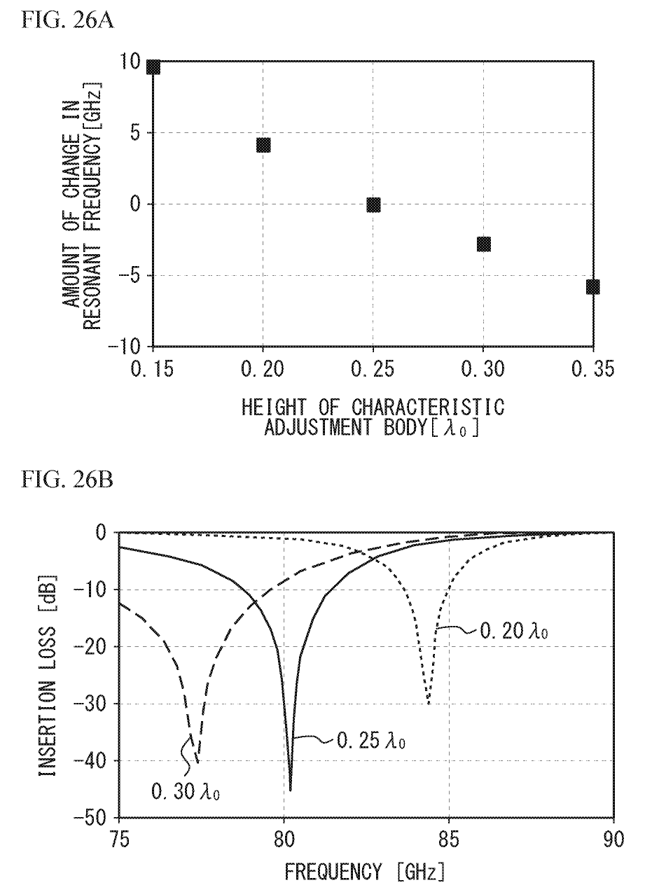

FIGS. 26A and 26B illustrate simulation results when the height of the characteristic adjustment body 60a is changed in the waveguide device 400 according to the fourth embodiment. FIG. 26A illustrates the simulation result of the amount of change in the resonance frequency with respect to the height of the characteristic adjustment body 60a, and FIG. 26B illustrates the simulation result of the insertion loss with respect to the frequency. In FIG. 26A, the amount of change is calculated with reference to the value when the height of the characteristic adjustment body 60a is 0.25λ0 (λ0/4) which is the same as the height of the ridge 30.

As illustrated in FIGS. 26A and 26B, the value of the resonance frequency changed as the height of the characteristic adjustment body 60a changed. These are the same results as those of FIG. 4A and FIG. 5A of the second embodiment. Therefore, even when the characteristic adjustment body 60a is provided, the optical waveguide device can be adjusted to desired characteristics by adjusting the height of the characteristic adjustment body 60a, as in the case where the characteristic adjustment body 60 is provided as in the second embodiment. Further, by changing the shape of the characteristic adjustment body 60a, the optical waveguide device can be adjusted to desired characteristics, as in the characteristic adjustment body 60 of the second embodiment.

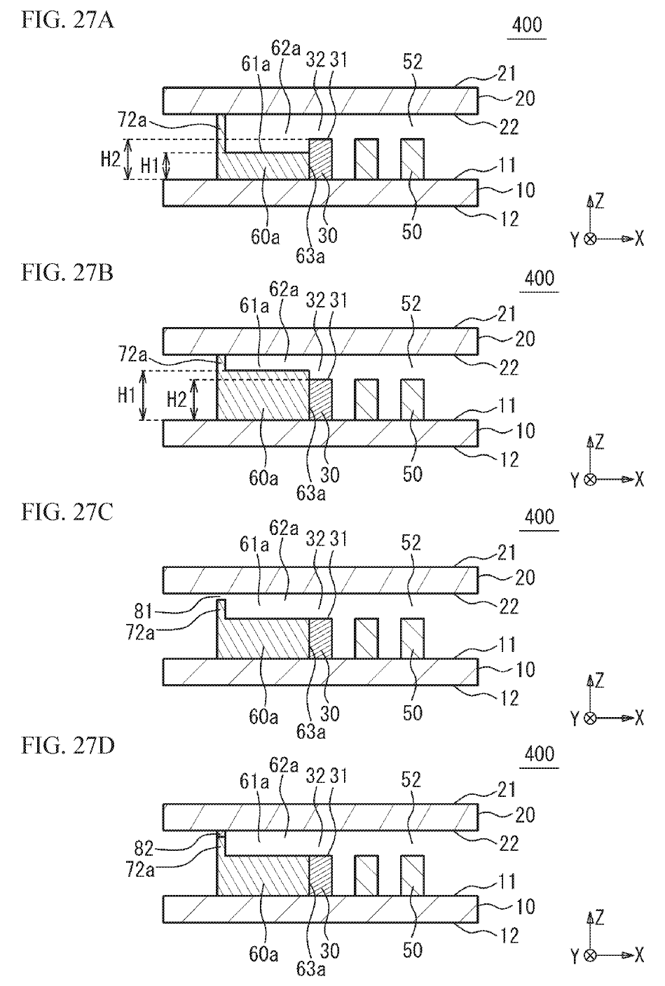

From the above simulation results, it is understood that the characteristics of the optical waveguide device can be controlled by changing the height of the characteristic adjustment body 60a also in the characteristic adjustment body 60a, similarly to the characteristic adjustment body 60 of the second embodiment. Therefore, an example of a case where the height of the characteristic adjustment body 60a is changed is illustrated in FIGS. 27A and 27B. Further, FIGS. 27C and 27D illustrate examples of the case where the conductor 72a of the characteristic adjustment body 60a and the lower surface 22 of the second member 20 are high-frequency coupled.

FIGS. 27A and 27B are cross-sectional views of the case where the height of the characteristic adjustment body 60a is changed in the waveguide device 400 according to the fourth embodiment. As illustrated in FIGS. 27A and 27B, the height H1 of the characteristic adjustment body 60a is different from the height H2 of the ridge 30. FIG. 27A illustrates a case where the height H1 of the characteristic adjustment body 60a is lower than the height H2 of the ridge 30. FIG. 27B illustrates a case where the height H1 of the characteristic adjustment body 60a is higher than the height H2 of the ridge 30. As described above, the height H1 of the characteristic adjustment body 60a is different from the height H2 of the ridge 30 at least at a portion where the characteristic adjustment body 60a is connected.

FIGS. 27C and 27D are cross-sectional views of the case where the upper end of the conductor 72a of the characteristic adjustment body 60a is high-frequency coupled to the lower surface of the second member 20 in the waveguide device 400 according to the fourth embodiment. As illustrated in FIGS. 27C and 27D, the air gap 81 or the dielectric film 82 is provided between the conductor 72a of the characteristic adjustment body 60a and the lower surface 22 of the second member 20. Although the air gap 81 or the dielectric film 82 is provided, the end 64 of the characteristic adjustment body 60a and the lower surface 22 of the second member 20 are coupled to each other in a high-frequency manner in the used frequency band, and are in the high-frequency coupling state in which they are electrically connected to each other.

According to the fourth embodiment, as in the third embodiment, the characteristic adjustment body 60a having the second waveguide surface 61a with conductivity that faces the lower surface 22 of the second member 20 with the second air gap 62a interposed therebetween is disposed on the upper surface11 of the first member 10. The characteristic adjustment body 60a has one end 63a connected to the side of the ridge 30, and is in contact with or high-frequency coupled to the lower surface 22 of the second member 20 by the conductor 72a. This makes it possible to adjust the waveguide device to desired characteristics.

Also, in the fourth embodiment, as illustrated in FIGS. 27A and 27B, the height H1 of the second waveguide surface 61a of the characteristic adjustment body 60a from the upper surface 11 of the first member 10 is different from the height H2 of the first waveguide surface 31 of the ridge 30 from the upper surface 11 of the first member 10. In this way, the optical waveguide device can be adjusted to desired characteristics by adjusting the height H1 of the characteristic adjustment body 60a. Although FIGS. 27A and 27B illustrate examples where the entire second waveguide surface 61a is different in height from the first waveguide surface 31, this is not a limitation, and a portion of the second waveguide surface 61a may be different in height from the first waveguide surface 31.

Next, examples of various shapes of the characteristic adjustment body 60a in the first to eighth modifications will be described.

### First Modification

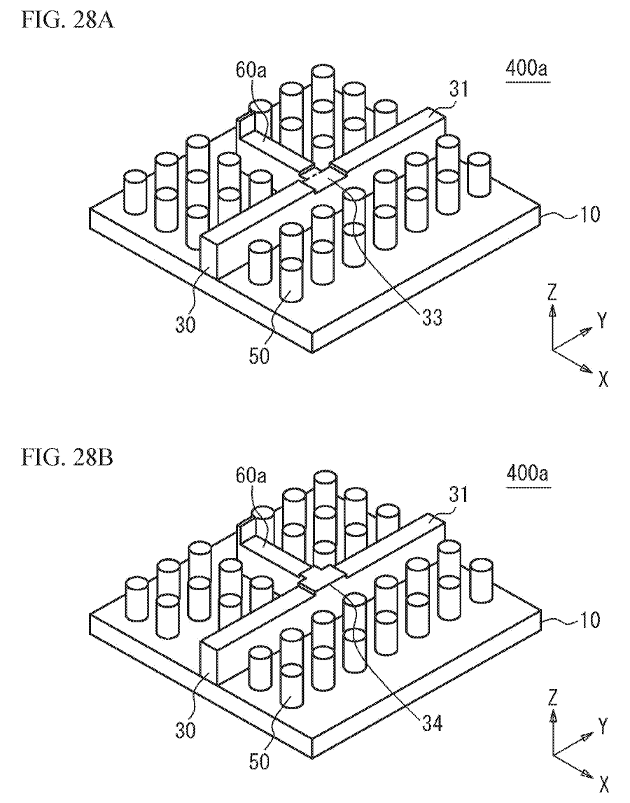

FIGS. 28A and 28B are perspective views of a waveguide device 400a according to a first modification of the fourth embodiment. As illustrated in FIGS. 28A and 28B, in the waveguide device 400a of the first modification of the fourth embodiment, the first waveguide surface 31 of the ridge 30 is provided with the recess 33 or the protrusion 34. The characteristic adjustment body 60a is connected to the side of the ridge 30 in the recess 33 or the protrusion 34. The height of the characteristic adjustment body 60a is different from the height of the ridge 30 in the recess 33 or the protrusion 34, for example. The other configurations of the first modification of the fourth embodiment are the same as those of the fourth embodiment, and thus the description thereof will be omitted. As described above, even when the characteristic adjustment body 60a is connected to the side of the ridge 30 in the recess 33 or the protrusion 34, the optical waveguide device can be adjusted to desired characteristics by adjusting the height of the characteristic adjustment body 60a. Although the case where the height of the characteristic adjustment body 60a is different from the height of the ridge 30 in the recess 33 or the protrusion 34 has been described as an example, the height of at least a part of the characteristic adjustment body 60a may be the same as the height of the ridge 30 in the recess 33 or the protrusion 34.

### Second and Third Modifications

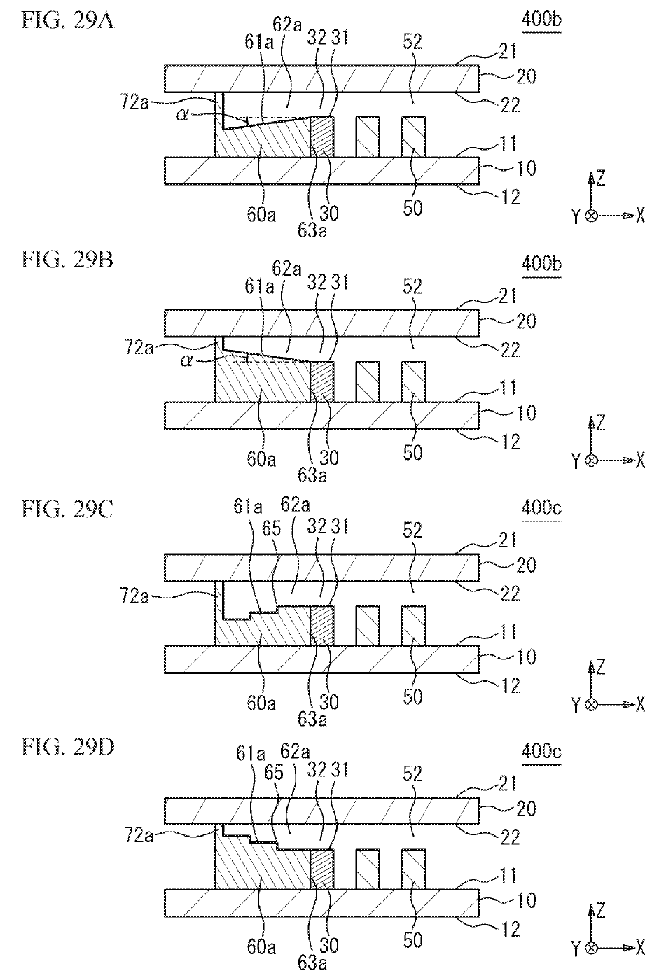

FIGS. 29A and 29B are cross-sectional views of a waveguide device 400b according to a second modification of the fourth embodiment. FIGS. 29C and 29D are cross-sectional views of a waveguide device 400c according to a third modification of the fourth embodiment. As illustrated in FIGS. 29A and 29B, in the waveguide device 400b according to the second modification of the fourth embodiment, the height of the characteristic adjustment body 60a changes in a slope shape from the end 63a toward the conductor 72a. The other configurations of the second modification of the fourth embodiment are the same as those of the fourth embodiment, and thus the description thereof will be omitted. Thus, the height of the second waveguide surface 61a of the characteristic adjustment body 60a from the upper surface 11 of the first member 10 may change in the slop shape. By adjusting the inclination angle α of the slope shape, the waveguide device can be adjusted to have desired characteristics, as in the second modification of the second embodiment.

As illustrated in FIGS. 29C and 29D, in the waveguide device 400c according to the third modification of the fourth embodiment, the height of the characteristic adjustment body 60a changes stepwise from the end 63a toward the conductor 72a. The other configurations of the third modification of the fourth embodiment are the same as those of the fourth embodiment, and thus the description thereof will be omitted. Thus, the characteristic adjustment body 60a may have the step portion 65 in the second waveguide surface 61a, and the height from the upper surface11 of the first member 10 may change stepwise. In this case, the optical waveguide device can be adjusted to desired characteristics by changing the height of the characteristic adjustment body 60a.

In the second and third modifications of the fourth embodiment, the height of the characteristic adjustment body 60a at the end 63a is the same as the height of the ridge 30 at the position where the end 63a is connected, but they may be different.

### Fourth Modification

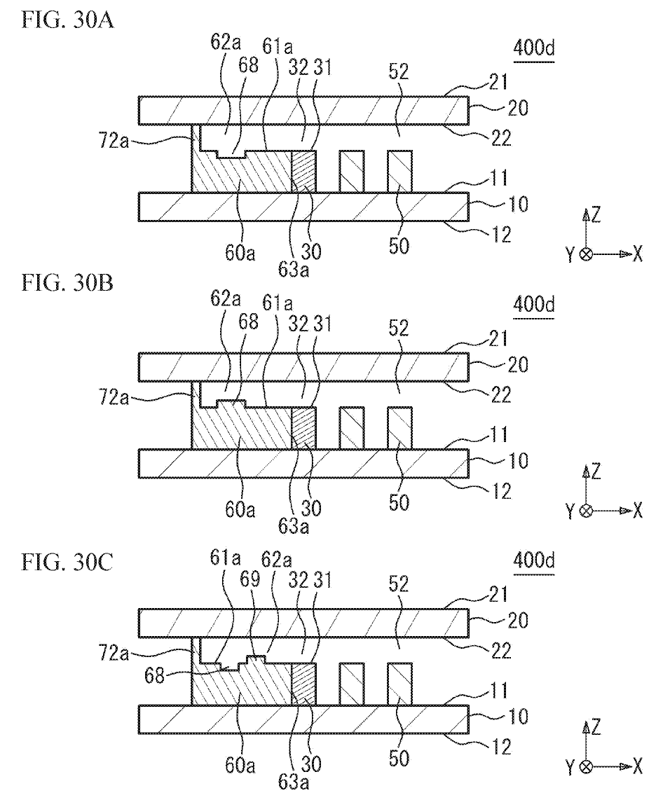

FIGS. 30A to 30C are cross-sectional views of a waveguide device 400d according to a fourth modification of the fourth embodiment. As illustrated in FIGS. 30A to 30C, in the waveguide device 400d of the fourth modification of the fourth embodiment, the second waveguide surface 61a of the characteristic adjustment body 60a is provided with the recess 68 and/or the protrusion 69. The other configurations of the fourth modification of the fourth embodiment are the same as those of the fourth embodiment, and thus the description thereof will be omitted. Thus, at least one of the recess 68 and the protrusion 69 may be provided in the second waveguide surface 61a of the characteristic adjustment body 60a. In this case, the optical waveguide device can be adjusted to desired characteristics by changing the height of the characteristic adjustment body 60a. The characteristic adjustment body 60a may include the step portion 65 of the third modification in addition to at least one of the recess 68 and the protrusion 69.

### Fifth and Sixth Modifications

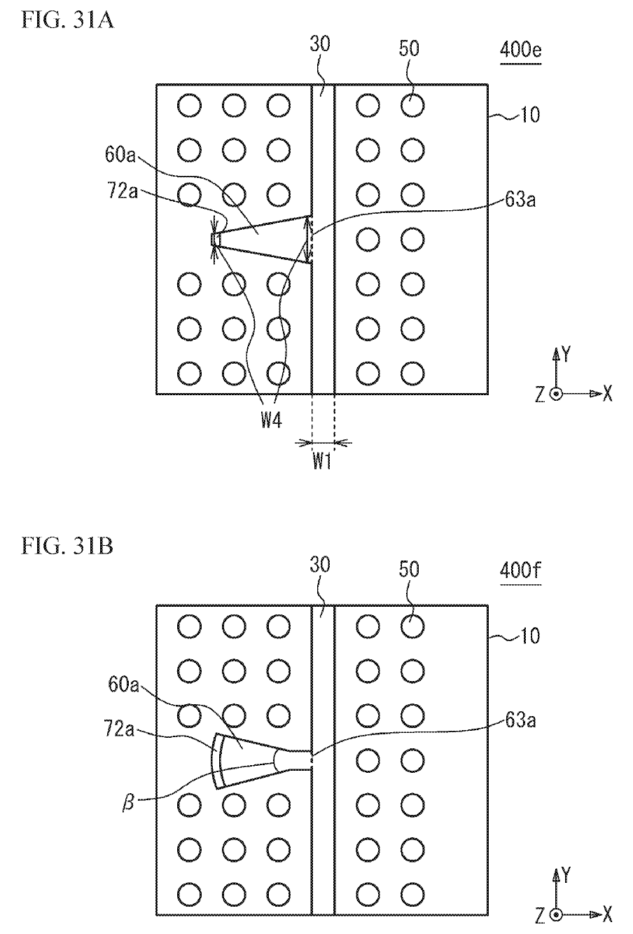

FIG. 31A is a plan view of a waveguide device 400e according to a fifth modification of the fourth embodiment. FIG. 31B is a plan view of a waveguide device 400f according to a sixth modification of the fourth embodiment. As illustrated in FIG. 31A, in the characteristic adjustment body 400e according to the fifth modification of the fourth embodiment, the width W4 at end 63a of the characteristic adjustment body 60a is wider than the width W4 at the other end where the conductor 72a is disposed in planar view. For example, the characteristic adjustment body 60a is tapered from the end 63a toward the conductor 72a. The width W4of the characteristic adjustment body 60a near the end 63 is larger than the width W1 of the ridge 30, for example. The width W4 of the characteristic adjustment body 60a near the conductor 72a is smaller than the width W1 of the ridge 30, for example. That is, the characteristic adjustment body 60a may include a portion larger than the width W1 of the ridge 30 as the width W4 of the characteristic adjustment body 60a, or may include a portion smaller than the width W1 of the ridge 30. The other configurations of the fifth modification of the fourth embodiment are the same as those of the fourth embodiment, and thus the description thereof will be omitted. In this manner, the characteristic adjustment body 60a may have the width W4 at the end 63a larger than the width W4 at the conductor 72a. By adjusting the area of the second waveguide surface 61 of the characteristic adjustment body 60a that is substantially parallel to the lower surface 22 of the second member 20, the characteristics of the waveguide device can be adjusted to desired characteristics.

As illustrated in FIG. 31B, in the waveguide device 400f according to the sixth modification of the fourth embodiment, the characteristic adjustment body 60a has a fan shape in planar view. The other configurations of the sixth modification of the fourth embodiment are the same as those of the fourth embodiment, and thus the description thereof will be omitted. In this manner, the characteristic adjustment body 60a may have a fan shape in at least a part thereof in planar view. By adjusting the central angle β of the fan shape, the waveguide device can be adjusted to have desired characteristics, as in the sixth modification of the second embodiment.

### Seventh and Eighth Modifications

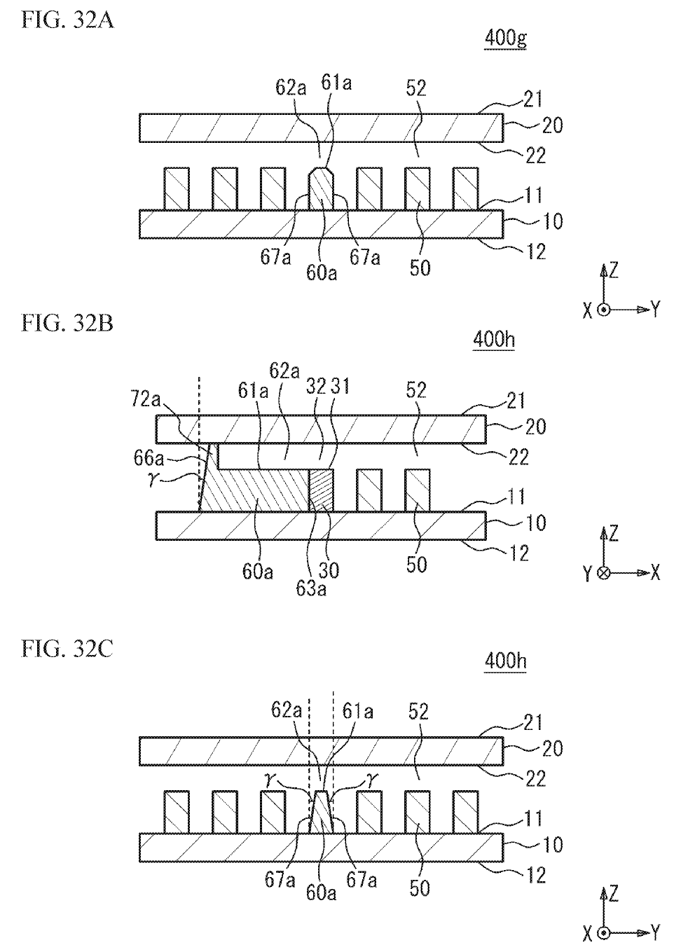

FIG. 32A is a cross-sectional view of a waveguide device 400g according to a seventh modification of the fourth embodiment. FIGS. 32B and 32C are cross-sectional views of a waveguide device 400h according to an eighth modification of the fourth embodiment. As in the waveguide device 400g according to the seventh modification of the fourth embodiment illustrated in FIG. 32A, the boundaries between the second waveguide surface 61a and side surfaces 67a of the characteristic adjustment body 60a may be chamfered. By adjusting the area of the second waveguide surface 61 of the characteristic adjustment body 60 that is substantially parallel to the lower surface 22 of the second member 20, the waveguide device can be adjusted to desired characteristics. The chamfering is not limited to the C-chamfering, and may be the R-chamfering. The other configurations of the seventh modification of the fourth embodiment are the same as those of the fourth embodiment, and thus the description thereof will be omitted.

As in the waveguide device 400h according to an eighth modification of the fourth embodiment illustrated in FIGS. 32B and 32C, at least one of a tip surface 66a and the side surface 67a of the characteristic adjustment body 60a may be a forward-tapered inclined surface with respect to the upper surface 11 of the first member 10. By adjusting the inclination angle γ, the waveguide device can be adjusted to have desired characteristics, as in the eighth modification of the second embodiment. In addition, when the characteristic adjustment body 60a is formed by molding with a mold, the characteristic adjustment body 60a can be easily taken out from the mold because the characteristic adjustment body has the inclined surface. The other configurations of the eighth modification of the fourth embodiment are the same as those of the fourth embodiment, and thus the description thereof will be omitted. In the eighth modification of the fourth embodiment, the inclination angle of the tip surface 66a and the inclination angle of the side surface 67a are the same, but may be different from each other. Further, the inclination angles of both side surfaces 67a may be different from each other. Further, only one of the both side surfaces 67a may be the inclined surface.

### Fifth Embodiment

A fifth embodiment is an example of a case where a characteristic adjustment body 60b having one end 63b connected to a through hole 90 and the other end 64b being an open end is provided on the upper surface 11 of the first member 10. FIG. 33A is a plan view of a waveguide device 500 according to a fifth embodiment, and FIGS. 33B and 33C are cross-sectional views taken along lines A-A and B-B in FIG. 33A, respectively.

As illustrated in FIGS. 33A to 33C, in the waveguide device 500 according to the fifth embodiment, the through hole 90 penetrating from the upper surface 11 to the lower surface 12 is provided in the first member 10. An end 37 of the ridge 30 is adjacent to the through hole 90. The through hole 90 has a conductive inner surface and functions as a waveguide that connects the waveguide formed in a layer below the first member 10 and the ridge waveguide on the ridge 30. Therefore, the electromagnetic wave transmitted through the ridge waveguide on the ridge 30 is extracted below the first member 10 via the through hole 90, or the electromagnetic wave transmitted through the ridge waveguide on the ridge 30 is supplied from below the first member 10 via the through hole 90.

The characteristic adjustment body 60b having at least an upper surface thereof being conductive is provided between the upper surface 11 of the first member 10 and the lower surface 22 of the second member 20. The characteristic adjustment body 60b has the end 63b in the -Y direction connected to the through hole 90, and the end 64b in the +Y direction as the open end. Since the end 63b of the characteristic adjustment body 60b is adjacent to the through hole 90, the characteristic adjustment body 60b is connected to a waveguide formed by the through hole 90 and the ridge 30. The end 63b of the characteristic adjustment body 60b faces the end 37 of the ridge 30 with the through hole 90 interposed therebetween, for example.

The side surface of the characteristic adjustment body 60b may have conductivity, and in this case, the end of the characteristic adjustment body 60b in the -Z direction is in contact with the upper surface 11 of the first member 10. The end of the characteristic adjustment body 60b in the +Z direction is not in contact with the lower surface 22 of the second member 20 and is separated from the lower surface 22 of the second member 20. The characteristic adjustment body 60b may have any shape. The upper surface (the end surface on the +Z direction side) of the characteristic adjustment body 60b that faces the lower surface 22 of the second member 20 serves as a second waveguide surface 61b with conductivity. A second air gap 62b is formed between the lower surface 22 of the second member 20 and the second waveguide surface 61b of the characteristic adjustment body 60b. A waveguide through which the electromagnetic wave is transmitted is formed in the second air gap 62b. The other configurations of the fifth embodiment are the same as those of the first embodiment, and thus the description thereof will be omitted.

According to the fifth embodiment, the characteristic adjustment body 60b having the second waveguide surface 61b that faces the lower surface 22 of the second member 20 with the second air gap 62b interposed therebetween is provided on the upper surface11 of the first member 10. The characteristic adjustment body 60b has one end 63b connected to the through hole 90 having a waveguide function and the other end 64b as the open end. By providing such the characteristic adjustment body 60b, the optical waveguide device can be adjusted to desired characteristics.

### Sixth Embodiment

In a sixth embodiment, various examples of a waveguide device including the characteristic adjustment body 60b will be described. FIG. 34A is a plan view of a waveguide device 600 according to the sixth embodiment, and FIGS. 34B to 34D are cross-sectional views of the waveguide device 600 according to the sixth embodiment. As illustrated in FIGS. 34A to 34D, the characteristic adjustment body 60b of the waveguide device 600 according to the sixth embodiment has a rectangular parallelepiped shape. The height of the characteristic adjustment body 60b may be the same as the height of the ridge 30 as illustrated in FIG. 34B, or may be different from the height of the ridge 30 as illustrated in FIGS. 34C and 34D. The other configurations of the sixth embodiment are the same as those of the fifth embodiment, and thus the description thereof will be omitted.

According to the sixth embodiment, the characteristic adjustment body 60b having the second waveguide surface 61b that faces the lower surface 22 of the second member 20 with the second air gap 62b interposed therebetween is provided on the upper surface11 of the first member 10. The characteristic adjustment body 60b has one end 63b connected to the through hole 90 having the waveguide function and the other end 64b as the open end. This makes it possible to adjust the characteristics of the electromagnetic wave transmitted through the ridge waveguide on the ridge 30 and the through hole 90, and to adjust the waveguide device to desired characteristics. For example, the electromagnetic wave transmitted through the ridge waveguide on the ridge 30 is supplied or extracted through the through hole 90, and the impedance changes at the connection portion between the ridge 30 and the through hole 90. By providing the characteristic adjustment body 60b adjacent to the through hole 90, the impedance at the connection portion between the ridge 30 and the through hole 90 can be matched with the impedance at the linear portion of the ridge 30.

In the sixth embodiment, as illustrated in FIGS. 34C and 34D, the height of the second waveguide surface 61b of the characteristic adjustment body 60b from the upper surface 11 of the first member 10 is different from the height of the first waveguide surface 31 of the ridge 30 from the upper surface 11 of the first member 10. In this way, the optical waveguide device can be adjusted to desired characteristics by adjusting the height of the characteristic adjustment body 60b. Although FIGS. 34C and 34D illustrate examples where the entire second waveguide surface 61b is different in height from the first waveguide surface 31, this is not a limitation, and a portion of the second waveguide surface 61b may be different in height from the first waveguide surface 31.

In the sixth embodiment, various modifications are conceivable with respect to the shape and arrangement of the characteristic adjustment body 60b. For example, the same modifications as those described in the second embodiment and FIGS. 2A to 23C can be adopted.

### Seventh Embodiment

A seventh embodiment is an example of a case where a characteristic adjustment body 60c is provided on the upper surface 11 of the first member 10, the characteristic adjustment body 60c having one end 63c adjacent to the through hole 90 and being in contact with or high-frequency coupled to the lower surface 22 of the second member 20 by a conductor 72b. FIG. 36A is a plan view of a waveguide device 700 according to a seventh embodiment, and FIGS. 36B and 36C are cross-sectional views taken along lines A-A and B-B in FIG. 36A, respectively.

As illustrated in FIGS. 36A to 36C, the characteristic adjustment body 60c having a conductive upper surface is provided between the upper surface 11 of the first member 10 and the lower surface 22 of the second member 20. The characteristic adjustment body 60c has the end 63c in the -Y direction connected to the through hole 90, and as one embodiment, the conductor 72b at the end in the +Y direction has conductivity at least on the side surface thereof and is in contact with or high-frequency coupled to the upper surface of the characteristic adjustment body 60a and the lower surface 22 of the second member 20. The end of the characteristic adjustment body 60c in the -Z direction is disposed on the upper surface 11 of the first member 10. The end of the characteristic adjustment body 60c in the +Z direction is not in contact with the lower surface 22 of the second member 20 except for the conductor 72b, and is separated from the lower surface 22 of the second member 20. The characteristic adjustment body 60c may have any shape. The upper surface (the end surface on the +Z direction side) of the characteristic adjustment body 60c that faces the lower surface 22 of the second member 20 serves as a second waveguide surface 61c with conductivity. A second air gap 62c is formed between the lower surface 22 of the second member 20 and the second waveguide surface 61c of the characteristic adjustment body 60c. A waveguide through which the electromagnetic wave is transmitted is formed in the second air gap 62c. The other configurations of the seventh embodiment are the same as those of the fifth embodiment, and thus the description thereof will be omitted.

According to the seventh embodiment, the characteristic adjustment body 60c having the second waveguide surface 61c with conductivity that faces the lower surface 22 of the second member 20 with the second air gap 62c interposed therebetween is disposed on the upper surface11 of the first member 10. The characteristic adjustment body 60c has one end 63c connected to the through hole 90 having the waveguide function, and is in contact with or high-frequency coupled to the lower surface 22 of the second member 20 by the conductor 72b. By providing such the characteristic adjustment body 60c, the optical waveguide device can be adjusted to desired characteristics.

### Eighth Embodiment

In an eighth embodiment, various examples of a waveguide device including the characteristic adjustment body 60c will be described. FIG. 37A is a plan view of a waveguide device 800 according to the eighth embodiment, and FIGS. 37B to 37D are cross-sectional views of the waveguide device 800 according to the eighth embodiment. As illustrated in FIGS. 37A to 37D, in the wave guide device 800 according to the eighth embodiment, the characteristic adjustment body 60c has a rectangular parallelepiped shape except for the conductor 72b. The height of the characteristic adjustment body 60c may be the same as the height of the ridge 30 as illustrated in FIG. 37B, or may be different from the height of the ridge 30 as illustrated in FIGS. 37C and 37D. The other configurations of the eighth embodiment are the same as those of the seventh embodiment, and thus the description thereof will be omitted.

According to the eighth embodiment, the characteristic adjustment body 60c having the second waveguide surface 61c with conductivity that faces the lower surface 22 of the second member 20 with the second air gap 62c interposed therebetween is disposed on the upper surface11 of the first member 10. The characteristic adjustment body 60c has one end 63c connected to the through hole 90 having the waveguide function, and is in contact with or high-frequency coupled to the lower surface 22 of the second member 20 by the conductor 72b. This makes it possible to adjust the waveguide device to desired characteristics.

In the eighth embodiment, as illustrated in FIGS. 37C and 37D, the height of the second waveguide surface 61c of the characteristic adjustment body 60c from the upper surface 11 of the first member 10 is different from the height of the first waveguide surface 31 of the ridge 30 from the upper surface 11 of the first member 10. As described above, by adjusting the height of the characteristic adjustment body 60c, the optical waveguide device can be adjusted to desired characteristics, as in the second embodiment. Although FIGS. 37C and 37D illustrate examples where the entire second waveguide surface 61c is different in height from the first waveguide surface 31, this is not a limitation, and a portion of the second waveguide surface 61c may be different in height from the first waveguide surface 31.

In the eighth embodiment, various modifications can be considered with respect to the shape and arrangement of the characteristic adjustment body. For example, the same modifications as those described in the fourth embodiment and FIGS. 25 to 32 can be adopted.

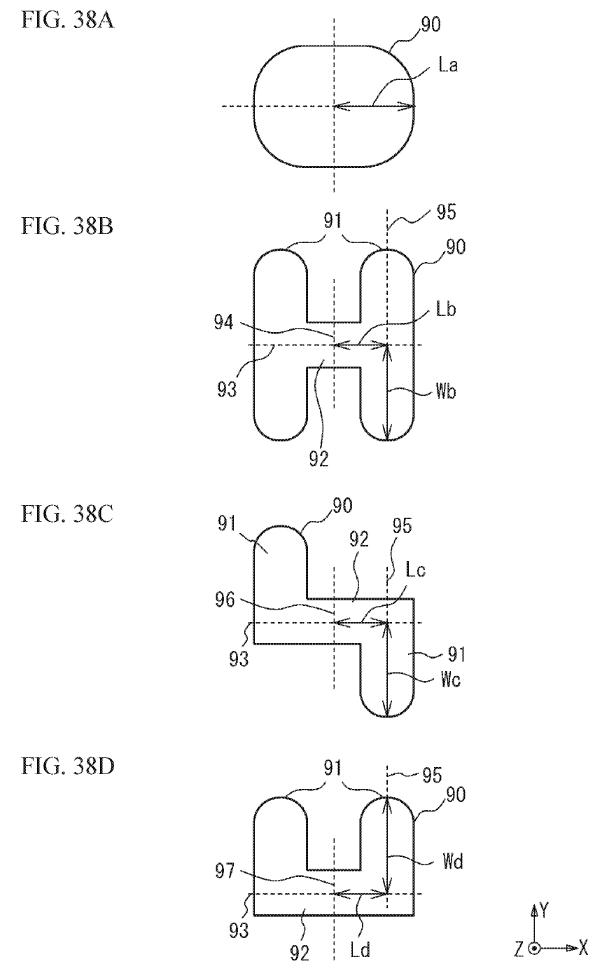

In the fifth embodiment to the eighth embodiment, the case where the through hole 90 has a rectangular shape in planar view in the Z-axis direction is illustrated as an example, but the present disclosure is not limited to this case. FIGS. 38A to 38D are plan views illustrating other examples of the through hole. As illustrated in FIG. 38A, the through hole 90 may have an oval shape in planar view in the Z-axis direction. In this case, the major radius La is set so that high-order resonance does not occur and the impedance does not become excessively low. For example, the major radius La is set to λ0/4 < La < λ0/2. Note that the shape may be an elliptical shape instead of the oval shape.

As illustrated in FIG. 38B, the through hole 90 may have an H-shape having a pair of vertical portions 91 and a horizontal portion 92 connecting the pair of vertical portions 91 in planar view in the Z-axis direction. The horizontal portion 92 is substantially perpendicular to the pair of vertical portions 91 and connects substantially central portions of the pair of vertical portions 91. A distance between an intersection of a center line 93 of the horizontal portion 92 and a center line 94 of the entire H-shape perpendicular to the horizontal portion 92 and an intersection of the center line 93 and a center line 95 of the vertical portion 91 is denoted by Lb. A distance between an intersection of the center line 93 and the center line 95 and an end of the vertical portion 91 is denoted by Wb. The sum of Lb and Wb is set so as to satisfy λ0/4 < Lb + Wb < λ0/2. By making the distance Wb relatively long, the distance Lb can be made relatively short. This allows the width of the H-shape in the X-axis direction to be less than λ0/2, for example, and an interval between the horizontal portions 92 in the length direction to be reduced.

As illustrated in FIG. 38C, the through hole 90 may have a shape including the horizontal portion 92 and the pair of vertical portions 91 extending from both ends of the horizontal portion 92 in planar view in the Z-axis direction. Directions in which the pair of vertical portions 91 extend from the horizontal portion 92 are substantially perpendicular to the horizontal portion 92 and are opposite to each other. A distance between an intersection of the center line 93 of the horizontal portion 92 and a center line 96 of the overall shape perpendicular to the horizontal portion 92 and an intersection of the center line 93 and the center line 95 of the vertical portion 91 is denoted by Lc. A distance between the intersection of the center line 93 and the center line 95 and the end of the vertical portion 91 is denoted by Wc. The sum of Lc and Wc is set so as to satisfy λ0/4 < Lc + Wc < λ0/2. By making the distance Wc relatively long, the distance Lc can be made relatively short. Accordingly, the width of the entire shape in the X-axis direction can be made less than λ0/2, for example, and the interval of the horizontal portions 92 in the length direction can be shortened.

As illustrated in FIG. 38D, the through hole 90 may have a U-shape having the horizontal portion 92 and the pair of vertical portions 91 extending from both ends of the horizontal portion 92 in the same direction perpendicular to the horizontal portion 92 in planar view in the Z-axis direction. This shape can be considered as the shape of the upper half of the H-shape. A distance between an intersection of the center line 93 of the horizontal portion 92 and a center line 97 of the entire U-shape perpendicular to the horizontal portion 92 and an intersection of the center line 93 and the center line 95 of the vertical portion 91 is denoted by Ld. A distance between the intersection of the center line 93 and the center line 95 and an end of the vertical portion 91 is denoted by Wd. The sum of Ld and Wd is set so as to satisfy λ0/4 < Ld + Wd < λ0/2. By making the distance Wd relatively long, the distance Ld can be made relatively short. Thereby, the width of the U-shape in the X-axis direction can be made less than λ0/2, for example, and the interval of the horizontal portions 92 in the length direction can be shortened.

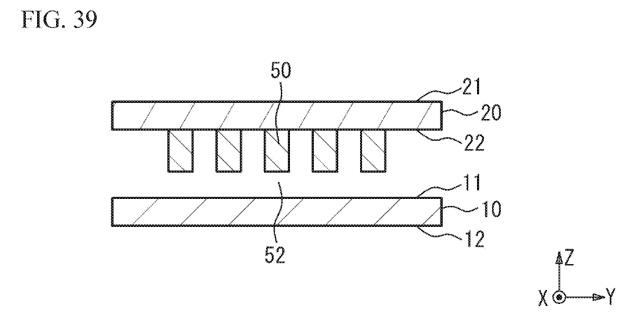

In the first to eighth embodiments, the rod 50 extends from the upper surface 11 of the first member 10 toward the second member 20, and the third air gap 52 is formed between the rod 50 and the lower surface 22 of the second member 20. FIG. 39 is a cross-sectional view illustrating another example of the rod. As illustrated in FIG. 39, the rod 50 may extend from the lower surface 22 of the second member 20 toward the first member 10, and the third air gap 52 may be formed between the rod 50 and the upper surface 11 of the first member 10.

Next, the following description will explain the range of the shape and the like to which the structure of the characteristic adjustment body according to the disclosure described above can be applied.
(1) First, the characteristic adjustment body according to the present disclosure is applicable as a waveguide device in which the side surface includes a tapered inclined surface, which serves as a draft angle during manufacturing the characteristic adjustment body. This is described in FIGS. 17A and 17B, FIG. 32C, and the text describing these figures.
(2) The characteristic adjustment body according to the present disclosure is applicable as a waveguide device in which the height of the highest portion of the second waveguide surface is higher than the height of the first waveguide surface of the ridge with reference to the upper surface of the first member. This is described in FIGS. 6B, 7B, 9B, 11B, 12B, 12C, 14C, 27B, 29B, 29D, 30B, 30C, 34D, and 37D and the text describing these figures.
(3) The characteristic adjustment body according to the present disclosure is applicable as a waveguide device in which the height of the lowest portion of the second waveguide surface is lower than the height of the first waveguide surface of the ridge with reference to the upper surface of the first member. This is described in FIGS. 6A, 7A, 9A, 11A, 12A, 12C, 14B, 27A, 29A, 29C, 30A, 30C, 34C, and 37C, and the text describing these figures.
(4) The characteristic adjustment body according to the present disclosure is applicable as a waveguide device including a portion in which a width between two side surfaces of the characteristic adjustment body in the longitudinal direction is larger than a width between two side surfaces of the ridge in the longitudinal direction. This is described in FIGS. 13, 14A to 14C, 31A and 31B, and the text describing these figures. Here, "longitudinal direction" refers to a direction corresponding to the long side of a rectangle when the outer shape of the characteristic adjustment body is approximated to the rectangle in plan view from the +Z axis direction.
(5) The characteristic adjustment body according to the present disclosure is applicable as a waveguide device including a portion in which a width between two side surfaces of the characteristic adjustment body in the longitudinal direction is smaller than a width between two side surfaces of the ridge in the longitudinal direction. This is described in FIGS. 13, 14A to 14C, 31A and 31B, and the text describing these figures.
(6) A characteristic adjustment body according to the present disclosure is applicable as a waveguide device including at least one of the recess, the protrusion, and the step portion in the second waveguide surface. This is described in FIGS. 11A and 11B, FIGS. 12A to 12C, FIGS. 29C and 29D, FIGS. 30A to 30C, and the text describing these figures.
(7) A characteristic adjustment body according to the present disclosure is applicable as a waveguide device including the inclined portion in the second waveguide surface. This is described in FIGS. 9A and 9B, 16A and 16B, 17A and 17B, 24B, 29A and 29B, 32A to 32C, 33B, 36B, and the text describing these figures.

Although the embodiments of the present disclosure have been described in detail above, the present disclosure is not limited to the specific embodiments, and various change, substitutions, and alterations could be made hereto without departing from the spirit and scope of the claimed invention.

What is claimed is:

1. A waveguide device comprising:
a first member having an upper surface with conductivity;
a second member having a lower surface with conductivity, the lower surface facing the upper surface of the first member;
a ridge disposed on the upper surface of the first member between the upper surface of the first member and the lower surface of the second member, the ridge forming a first air gap between the ridge and the lower surface of the second member, the ridge having a first waveguide surface with conductivity facing the lower surface of the second member;
a characteristic adjustment body disposed on the upper surface of the first member between the upper surface of the first member and the lower surface of the second member, the characteristic adjustment body having a second waveguide surface with conductivity facing the lower surface of the second member with a second air gap interposed therebetween, the characteristic adjustment body having one end connected to a side of the ridge and another end being an open end; and
a plurality of rods provided at least around the ridge and the characteristic adjustment body between the upper surface of the first member and the lower surface of the second member, each of the plurality of rods being in contact with one of the upper surface of the first member and the lower surface of the second member and forming a third gap between the rods and another of the upper surface and the lower surface, each of the plurality of rods having at least an upper surface with conductivity and a side surface with conductivity.

2. A waveguide device comprising:
a first member having an upper surface with conductivity;
a second member having a lower surface with conductivity, the lower surface facing the upper surface of the first member;
a ridge disposed on the upper surface of the first member between the upper surface of the first member and the lower surface of the second member, the ridge forming a first air gap between the ridge and the lower surface of the second member, the ridge having a first waveguide surface with conductivity facing the lower surface of the second member;
a characteristic adjustment body disposed on the upper surface of the first member between the upper surface of the first member and the lower surface of the second member, the characteristic adjustment body having a second waveguide surface with conductivity facing the lower surface of the second member with a second air gap interposed therebetween, the characteristic adjustment body having one end connected to a side of the ridge, at least a portion of the second waveguide surface being in contact with or high-frequency coupled to the lower surface of the second member by a conductor; and
a plurality of rods provided at least around the ridge and the characteristic adjustment body between the upper surface of the first member and the lower surface of the second member, each of the plurality of rods being in contact with one of the upper surface of the first member and the lower surface of the second member and forming a third gap between the rods and another of the upper surface and the lower surface, each of the plurality of rods having at least an upper surface with conductivity and a side surface with conductivity.

3. A waveguide device comprising:
a first member having an upper surface with conductivity and a through hole having a waveguide function;
a second member having a lower surface with conductivity, the lower surface facing the upper surface of the first member;
a ridge disposed on the upper surface of the first member between the upper surface of the first member and the lower surface of the second member, the ridge forming a first air gap between the ridge and the lower surface of the second member, the ridge having a first waveguide surface with conductivity facing the lower surface of the second member, the ridge having one end connected to the through hole;
a characteristic adjustment body disposed on the upper surface of the first member between the upper surface of the first member and the lower surface of the second member, the characteristic adjustment body having a second waveguide surface with conductivity facing the lower surface of the second member with a second air gap interposed therebetween, (i) the characteristic adjustment body having one end connected to the through hole and another end being an open end or (ii) the characteristic adjustment body having one end connected to the through hole, at least a portion of the second waveguide surface being in contact with or high-frequency coupled to the lower surface of the second member by a conductor; and
a plurality of rods provided at least around the ridge and the characteristic adjustment body between the upper surface of the first member and the lower surface of the second member, each of the plurality of rods being in contact with one of the upper surface of the first member and the lower surface of the second member and forming a third gap between the rods and another of the upper surface and the lower surface, each of the plurality of rods having at least an upper surface with conductivity and a side surface with conductivity.

4. The waveguide device according to claim 1,
wherein the characteristic adjustment body includes a tapered inclined side surface, and the tapered inclined side surface is a draft angle during manufacturing the characteristic adjusting body.

5. The waveguide device according to claim 1,
wherein a height of a highest portion of the second waveguide surface of the characteristic adjustment body is higher than a height of the first waveguide surface of the ridge with reference to the upper surface of the first member.

6. The waveguide device according to claim 1,
wherein a height of a lowest portion of the second waveguide surface of the characteristic adjustment body is lower than a height of the first waveguide surface of the ridge with reference to the upper surface of the first member.

7. The waveguide device according to claim 1,
wherein the characteristic adjustment body includes a portion in which a width between two side surfaces of the characteristic adjustment body in a longitudinal direction is larger than a width between two side surfaces of the ridge in the longitudinal direction.

8. The waveguide device according to claim 1,
wherein the characteristic adjustment body includes a portion in which a width between two side surfaces of the characteristic adjustment body in a longitudinal direction is smaller than a width between two side surfaces of the ridge in the longitudinal direction.

9. The waveguide device according to claim 1,
wherein the characteristic adjustment body includes at least one of a recess, a protrusion, and a step portion in the second waveguide surface.

10. The waveguide device according to claim 1,
wherein the characteristic adjustment body includes an inclined portion in the second waveguide surface.

11. The waveguide device according to claim 1, further comprising
a wall portion disposed between the upper surface of the first member and the lower surface of the second member so as to be adjacent to the characteristic adjustment body without the plurality of rods interposed therebetween, the wall portion having conductivity at least on a side surface facing the characteristic adjustment body,
wherein the side surface of the wall portion having conductivity is in contact with or high-frequency coupled to the upper surface of the first member and the lower surface of the second member.
